(19) United States
(12) Patent Application Publication
(10) Pub. No.: US 2013/0165134 A1
(43) Pub. Date: Jun. 27, 2013

(54) METHODS, APPARATUS, AND SYSTEMS FOR DYNAMIC SPECTRUM ALLOCATION

(71) Applicant: InterDigital Patent Holdings, Inc., Wilmington, DE (US)

(72) Inventors: Athmane Touag, Chomedey Laval (CA); Joseph M. Murray, Schwenksville, PA (US); Liangping Ma, San Diego, CA (US); Zinan Lin, Melville, NY (US); Alpaslan Demir, East Meadow, NY (US); Catalina M. Mladin, Hatboro, PA (US); Martino Freda, Laval (CA); Mihaela C. Beluri, Jericho, NY (US); Jean-Louis Gauvreau, La Prairie (CA); Ravikumar V. Pragada, Collegeville, PA (US)

(73) Assignee: InterDigital Patent Holdings, Inc., Wilmington, DE (US)

(21) Appl. No.: 13/721,421

(22) Filed: Dec. 20, 2012

Related U.S. Application Data
(60) Provisional application No. 61/579,145, filed on Dec. 22, 2011.

(51) Int. Cl. H04W 72/04

(52) U.S. Cl. CPC H04W 72/0486
USPC 455/452.1

(57) ABSTRACT

Systems and methods are described generally related to the creation of a spectrum allocator (SA) function that can be used to dynamically assign/reassign the frequency of operation of a node operating in a wireless communication network. To permit LTE operation in license exempt (LE) bands, the radio resource management (RRM) system is enhanced to include an interface, which allows it to communicate with modules external to the RRM, such as a coexistence manager, policy engine and sensing toolbox.

### CROSS-REFERENCE TO RELATED APPLICATIONS

This application claims priority from U.S. Provisional Application No. 61/579,145, filed on Dec. 22, 2011, the contents of which are incorporated fully by reference herein.

### BACKGROUND

As the number of mobile users continues to increase, additional licensed band spectrum is needed to support these mobile users. However, licensed band spectrum is not readily available and may be very expensive to acquire. Therefore, it is highly desirable to deploy cellular radio access technologies (RATs) such as, for example, long-term evolution (LTE), in newly available spectrum such as television white space (TVWS), LSA (Licensed Shared Access) bands, ISM bands, licensed exempt or other unlicensed bands, and any other shared spectrum.

Operation of the deployed RATs in TVWS or unlicensed bands may be modified to mitigate uncoordinated interfering spectrum usage, as well as to support uplink (UL) and downlink (DL) operation without the need for fixed frequency duplex operation. For example, the spacing between available channels in TVWS may depend on the current location and use of the TVWS by primary users in the vicinity. Furthermore, some areas may only have one single TVWS channel available, which may result in having to operate and provide both UL and DL resources on a single TVWS channel. In addition, operation over licensed exempt (LE) bands may be subject to the lower reliability of these channels (as compared to operation over the licensed bands), and to frequently stoppage of operation on a given channel due to a high level of interference, the arrival of a primary incumbent, coexistence database decisions, and the like. Hence, methods, systems, and apparatus for dynamically monitoring and/or allocating spectrum are useful.

### SUMMARY

In one embodiment, a method implemented in a base station to monitor a spectrum for availability for use includes receiving from a management entity a list of candidate channels within the spectrum and monitoring at least one of the candidate channels in the list for candidacy for use.

In one embodiment, a system for allocating wireless communication channels within a spectrum includes: a coexistence manager adapted to transmit a list of candidate channels within the spectrum; a wireless transmit/receive unit (WTRU); a base station in communication with the coexistence manager and the wireless transmit/receive unit, the base station configured to receive from a management entity a list of candidate channels within the spectrum and monitor at least one of the candidate channels in the list for candidacy for use by the base station.

In one embodiment, a method implemented in a base station for allocating use by the base station of channels within a Licensed Exempt spectrum includes receiving from a coexistence management entity a list of candidate channels within the spectrum, monitoring at least one of the candidate channels in the list for candidacy for use, using at least one of the candidate channels for communications with a wireless transmit/receive unit (WTRU), detecting when a change in the status of the at least one channel has occurred, responsive to detection of a change in status of the at least one channel, determining whether the at least one channel is still available for use by the base station, and, if it is determined that the at least one channel is not available for use by the base station, switching to a different channel.

In one embodiment, a method for switching communications between a base station and at least one wireless transmit/receive unit (WTRU) from a first channel in a Licensed Exempt spectrum to a second channel includes receiving at the base station a channel switch request that identifies the second channel to which communications is to be switched, creating at the base station a MAC PDU containing a Channel Switch MAC CE, the Channel Switch MAC CE including information contained in the channel switch request, transmitting the MAC PDU from the base station to the at least one WTRU, receiving the MAC PDU at the at least one WTRU, transmitting from the base station to the at least one WTRU a RRC Connection Reconfiguration message, and reconfiguring the communication between the base station and the at least one WTRU using RRC messaging.

In one embodiment, a method for switching communications between a base station and at least one wireless transmit/receive unit (WTRU) from a first channel in a Licensed Exempt spectrum to a second channel includes receiving at the base station a channel switch request that identifies the second channel to which communications is to be switched, an RRC layer of the base station triggering a turn on of the second channel, creating an RRC portion of a channel switch message, and sending information to a MAC layer of the base station related to the second channel, the MAC layer determining a time at which the channel switch will occur and creating a MAC portion of the channel switch message containing an indication of the time at which the channel switch will occur, allocating the channel switch to a set of resource blocks, and mapping an associated channel switch DCI format to a PDCCH and PDSCH and transmitted the DCI to the at least one WTRU, a MAC layer of the WTRU reading the MAC section of the channel switch message and beginning using the designated parameters as of the channel switch time, and a RRC layer of the WTRU reading the MAC section of the channel switch message and reconfiguring measurements to be performed on the second channel in accordance therewith.

In one embodiment, a method for spectrum allocation includes assigning, by a spectrum allocator in a base station node, a first frequency of operation of a node in a wireless communication network within a licensed exempt band, and responsive to a triggering event, reassigning, by the spectrum allocator, the node to a second frequency of operation within the licensed exempt band.

### BRIEF DESCRIPTION OF THE DRAWINGS

A more detailed understanding may be had from the following description, given by way of example in conjunction with the accompanying drawings, wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows a logical architecture for a Home eNodeB (HeNB) that has a set of S1 interfaces to connect the HeNB to the evolved packet core (EPC);

FIG. 3 shows an E-UTRAN Architecture with deployed HeNB GW;

FIG. 4 shows the TV band spectrum usage;

FIG. 5 shows an example system architecture that comprises a Base Station (BS), a centralized Coexistence Manager (CM) and WTRUs;

FIG. 6 shows a base station policy engine;

FIG. 7 shows spectrum allocation initialization in accordance with one non-limiting embodiment;

FIG. 8 shows an embodiment of the setup of the Candidate Channel Monitoring procedure by the spectrum allocator;

FIGS. 9A-9B shows a reconfiguration of the Candidate Channels Monitoring procedure through different triggers;

FIG. 10 shows an embodiment of an Active Channel Management algorithm;

FIG. 11 shows MAC control element switching;

FIG. 12 shows a Channel-Switch MAC control element;

FIG. 13 shows an example logical flow of events involved in the MAC Layer Initiated channel change;

FIG. 14 is a timing diagram illustrating an exemplary uplink grant handling following a channel switch message;

FIG. 15 shows an example format for the channel switch DCI format and the associated channel switch message that the allocation points to in the PDSCH;

FIG. 16 shows an example sequence of events related to a cell change enabled through L1 control messaging;

FIG. 17 shows cross carrier scheduling using a license exempt carrier indicator field;

FIG. 18 shows an example timeline of events during the transition period for downlink transmission in terms of pending HARQ transmissions and ACK/NACKs;

FIG. 19 shows a block diagram of an eNB having a cell search engine; and

FIG. 20 shows example procedures of eNB enabled cell discovery, cell monitoring, and cell change.

### DETAILED DESCRIPTION

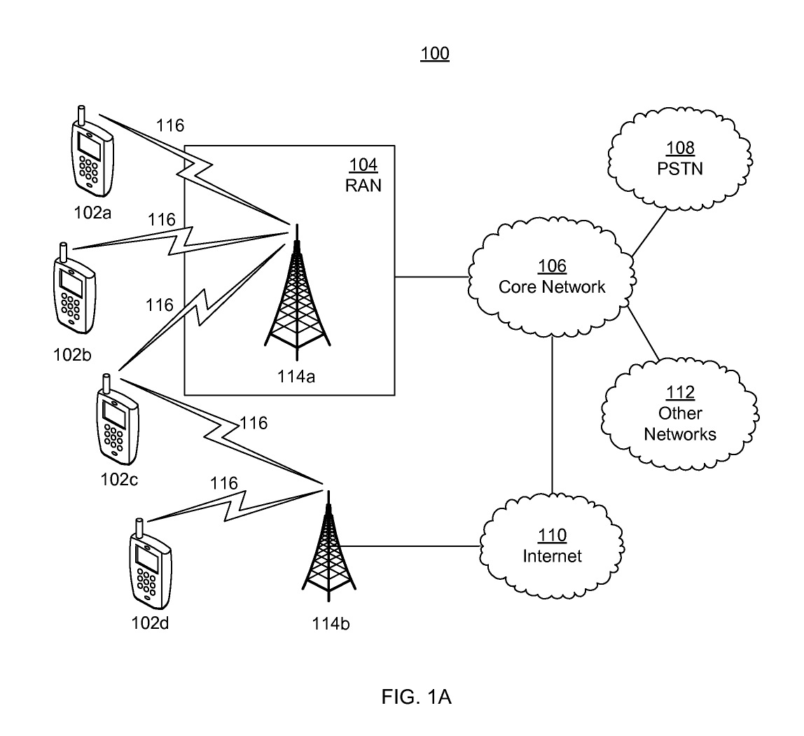

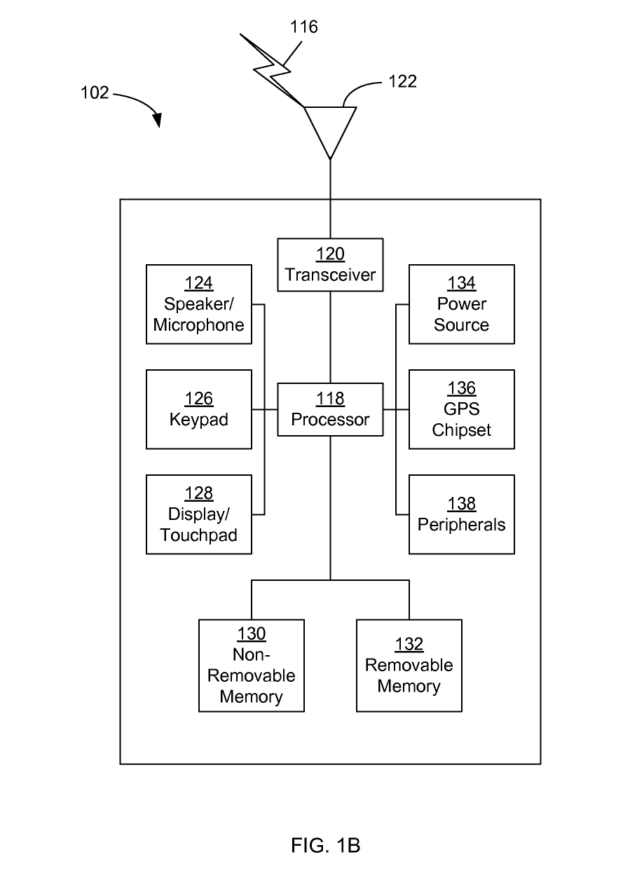

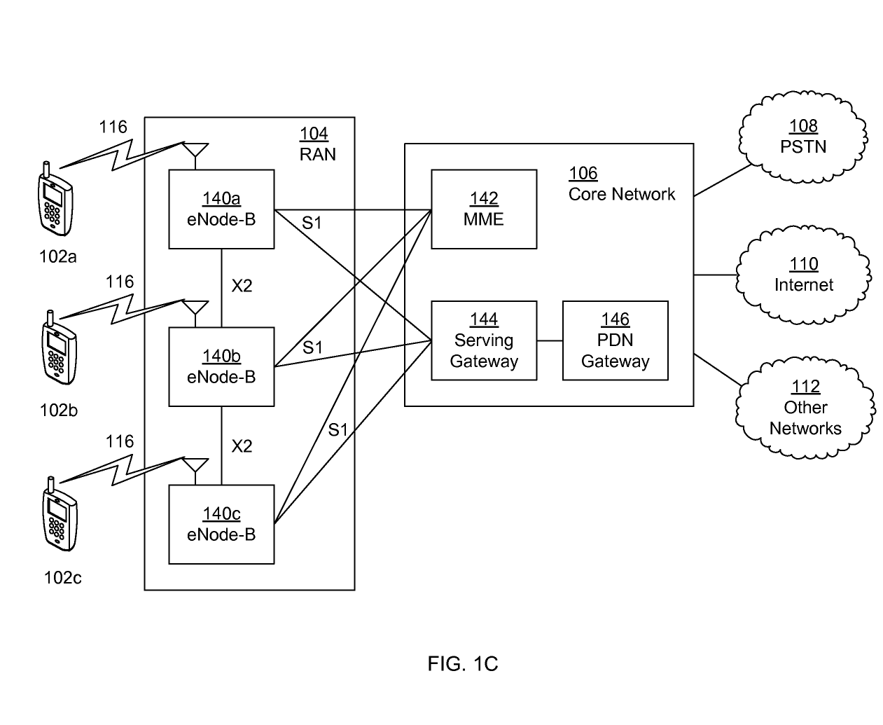

FIG. 1A is a diagram of an exemplary communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 140a, 140b, 140c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

The systems and methods described herein generally relate to the creation of a Spectrum Allocator (SA) function that may be used to dynamically assign/reassign the frequency of operation of a node operating in a wireless communication network. An example system architecture and suite of example procedures that may be used to implement an SA function at a wireless base station node operating in licensed and/or Licensed Exempt (LE) bands are described in more detail below.

Temporal variations in the channel availability and/or quality can occur due to the ad hoc addition and/or removal of network nodes. The frequency on which communications are being carried out between, for example, a base station on the one hand, and a User Equipment (UE) on the other hand may have to be changed dynamically to adapt to changes in network topology. For deployments where Licensed Exempt (LE) bands are used instead of or in addition to licensed bands, there is a need to coexist with primary users and/or other secondary users that may be sharing the spectrum. To facilitate the dynamic assignment/reassignment of the frequency of operation for a base station node in response to changes in the localized channel availability and/or quality, a Spectrum Allocator (SA) function may be utilized at the base station node.

To enable LTE operation in LE bands, as described in more detail below, the radio resource management (RRM) system may be enhanced to include an interface that allows it to communicate with modules external to the RRM, such as a Coexistence Manager, Policy Engine and Sensing Toolbox. Enhancements to RRM also include the addition of a Spectrum Allocation function.

Another approach to dynamic resource allocation uses the concept of escape channels, LE bands used for interference mitigation in environments where multiple LE bands are available. Thus, also provided below are systems and methods that do not necessary rely on a centralized coexistence manager (CM) entity. In such a system, the HeNB may make channel allocation decisions based on queries of the television white space (TVWS) database combined with local sensing/measurement reports.

Also described in more detail below is a candidate channel monitoring procedure where a base station interacts with a coexistence manager, selects at least one candidate channel, and configures cognitive-sensing capable WTRUs to start inter-frequency measurements to detect and determine secondary user usage or primary user usage on a channel. WTRUs report primary and secondary usage detection events to the Base Station through new RRC signaling.

Also described in more detail below is an Active Channel Monitoring procedure to monitor the use of an allocated channel via cognitive sensing, as well as other RAT-based measurements. The procedure includes algorithms that make use of RAT-based measurement reports and sensing to evaluate the availability and quality of the active channels. Also described is an exemplary set of events that could trigger a channel change at the eNB and the WTRUs or a reconfiguration of the measurements and sensing at the eNB as well as at the WTRUs.

Example methods to enable fast and seamless channel switching in the licensed exempt band for a system employing carrier aggregation of Licensed and LE cells are also described in more detail below. Also described is a cell switch to a preconfigured cell using MAC (Medium Access Control) CE (Control Entity) typically signaled to some or all WTRUs configured to operate in a given cell. Aspects of the systems and methods described below are the development of a preconfigured cell in the WTRUs and the eNB on which no measurement is performed by the WTRU and the fact that the eNB typically does not operate over preconfigured cells (for coexistence reasons).

Moreover, signaling alternatives to the new MAC CE are described, such as, for example, 1) a group based Channel Switch MAC Control Element; 2) L1 Control Signaling-Based Cell Change Mechanism; and 3) Use of Cross-Carrier Scheduling to Enable Cell Change.

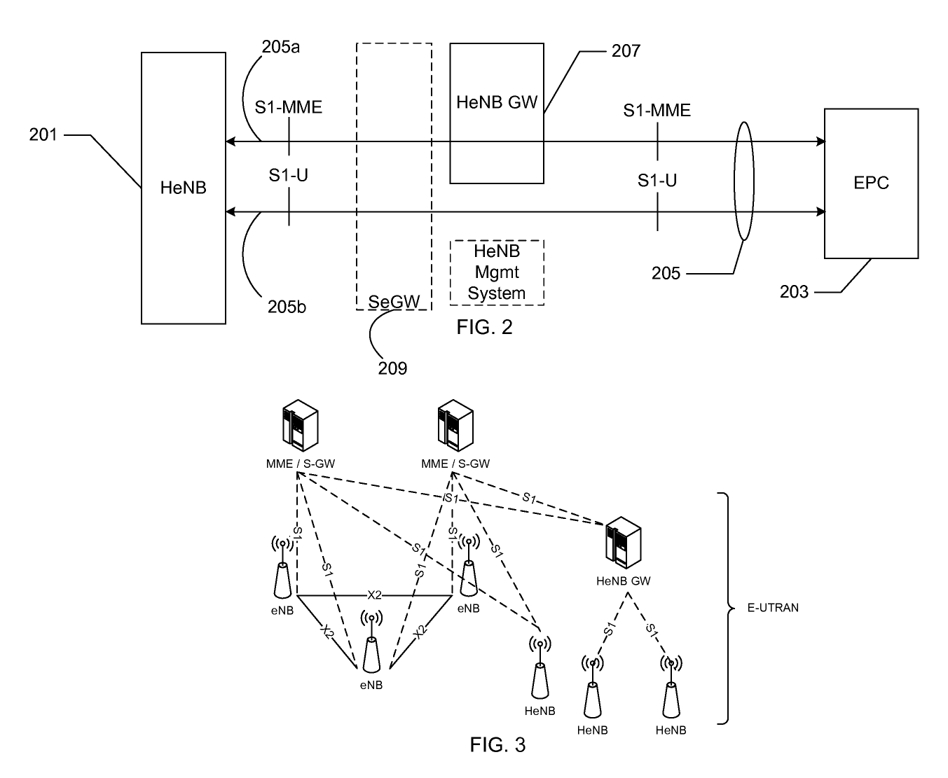

FIG. 2 shows a logical architecture for a Home eNodeB (HeNB) 201 that has a set of S1 interfaces 205 to connect the HeNB 201 to the Evolved Packet Core (EPC) 203. The configuration and authentication entities as shown in FIG. 2 may be common to HeNBs and HNBs. The E-UTRAN architecture may deploy a Home eNB Gateway (HeNB GW) 207 to allow the S1 interface between the HeNB 201 and the EPC 203 to scale to support a large number of HeNBs. The HeNB GW 207 serves as a concentrator for the C-Plane, specifically the S1-MME interface 205a. The S1-U interface 205b from the HeNB 201 may be terminated at the HeNB GW 207, or a direct logical U-Plane connection between HeNB 201 and S-GW (or SeGW) 209 may be used (as shown in FIG. 2). The S1 interface 205 is defined as the interface: (1) between the HeNB GW 207 and the Core Network 203, (2) between the HeNB 201 and the HeNB GW 207, (3) between the HeNB 201 and the Core Network 203, and (4) between an eNB and the Core Network.

The HeNB GW 207 appears to the MME 208 as an HeNB. The HeNB GW appears to the HeNB 201 as an MME. The S1 interface 205 between the HeNB 201 and the EPC 203 is the same whether or not the HeNB is connected to the EPC via a HeNB GW 207. The HeNB GW 207 may connect to the EPC 203 in such a way that inbound and outbound mobility to cells served by the HeNB GW may not necessarily require inter-MME handovers. One HeNB serves only one cell. The functions supported by the HeNB may be the same as those supported by an eNB (with the possible exception of NNSF) and the procedures run between a HeNB and the EPC may be the same as those between an eNB and the EPC. FIG. 3 shows an E-UTRAN Architecture with deployed HeNB GW.

A primary role of Radio Resource Management (RRM) is to ensure the efficient use of the available radio resources and to provide mechanisms that enable E-UTRAN to provide services that meet the QoS requirements of the attached users. Primary RRM functions are shown in the following publications, each of which is incorporated by reference in their entirety: TS 36.300, v10.1.0, Evolved Universal Terrestrial Radio Access (E-UTRA) and Evolved Universal Terrestrial Radio Access Network (E-UTRAN); Overall description; Stage 2 and Harri Holma & Antii Toskela, LTE for UMTS-OFDMA and SC-FDMA Based Radio Access, Wiley, 2009.

TV Whitespace (TVWS)

The analog TV bands include the Very High Frequency (VHF) band and the Ultra High Frequency (UHF) band. The VHF is composed of the low VHF band operating from 54 MHz to 88 MHz (excluding 72 MHz to 76 MHz), and the high VHF band operating from 174 MHz to 216 MHz. The UHF band is composed of the low UHF band operating from 470 MHz to 698 MHz, and the high UHF band operating from 698 MHz to 806 MHz.

Within the TV bands, each TV channel has 6 MHz bandwidth. Channels 2 to 6 are in the low VHF band; Channels 7 to 13 are in the high VHF band; Channels 14-51 are in the low UHF band; Channels 52 to 69 are in the high UHF band.

In the United State, the Federal Communications Commission (FCC) set Jun. 12, 2009 as the deadline of replacing analog TV broadcasting with digital TV broadcasting. The digital TV channel definitions are the same as the analog TV channel. The digital TV bands use analog TV channels 2 to 51 (except 37), while the analog TV channels 52 to 69 will be used for new non-broadcast users.

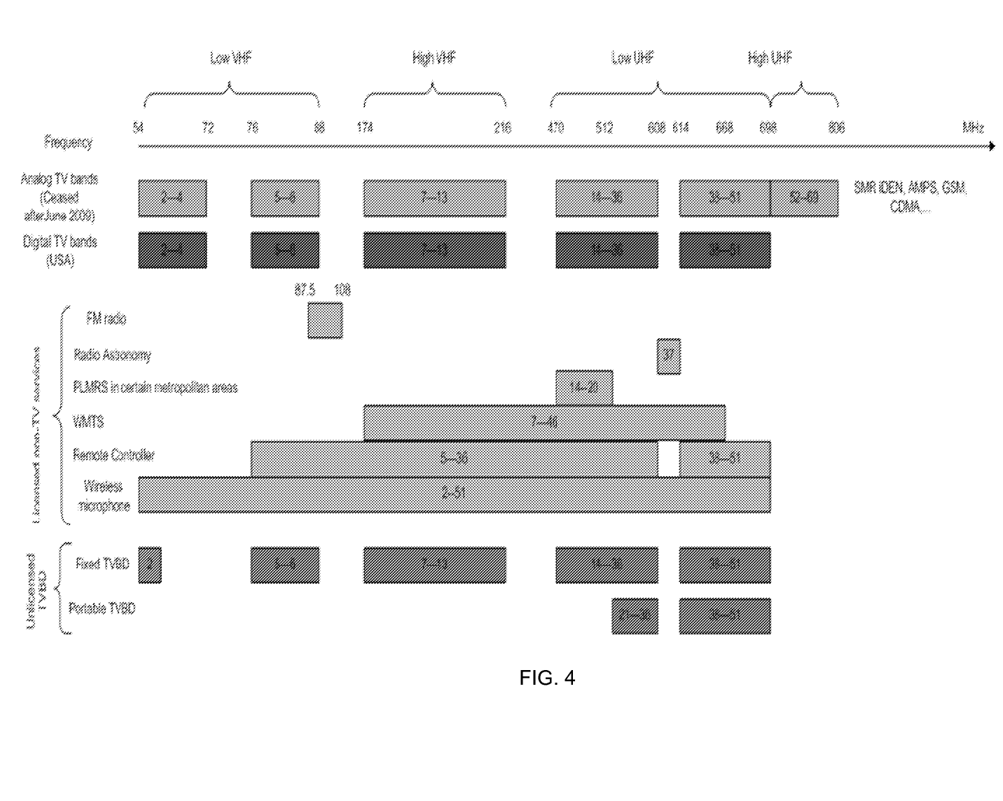

Frequency allocated to a broadcasting service but not used locally is called White Space (WS). TVWS refers to the TV channels 2 to 51 (except 37). Beside TV signals, there are other licensed signals transmitted on the TV bands. FCC Second Report and Order and Memorandum Opinion and Order, FCC 08-260, November 2008, which is incorporated by reference, includes additional details regarding other licensed signals transmitted on the TV bands. FIG. 4 shows TV band spectrum LE usage allocations. Particularly, channel 37 is reserved for radio astronomy and Wireless Medical Telemetry Service (WMTS), where the latter may operate on any vacant TV channel from 7 to 46. Private Land Mobile Radio Systems (PLMRS) may use channels 14 to 20 in certain metropolitan areas. Remote control devices may use any channels above channel 4, except channel 37. The starting frequency of FM channel 200 is 87.9 MHz, with partial overlapping on TV channel 6. Wireless microphones may use channels 2 to 51 with bandwidth of 200 kHz. According to FCC rule, wireless microphone usage is restricted to two pre-specified channels, and operation on other channels needs pre-registry. Additional details regarding this FCC rule may be found in the following publication, which is incorporated herein by reference: FCC Second Memorandum Opinion and Order, FCC 10-174, September 2010.

Furthermore, the FCC allows unlicensed radio transmitters to operate on the TVWS except channels 3, 4 and 37, as long as minimal interference is caused to licensed radio transmissions. Hence, the operation of unlicensed radio transmitters needs to satisfy several restrictions.

There are three kinds of unlicensed TV Band Devices (TVBDs): Fixed TVBD, Mode I portable (or personal) TVBD, and Mode II portable (or personal) TVBD. Both fixed TVBD and Mode II portable TVBDs must have geo-location/database access capability and must register to the TV band database. Access to the TV band database allows TVBDs to query the allowed TV channels, so as to avoid interfering with digital TV signals and licensed signals transmitted on the TV bands. The spectrum sensing is considered as an add-on feature for TVBDs to guarantee very little interference will be caused to digital TV signals and licensed signals. Furthermore, the sensing-only TVBD is allowed to operate on TVWS if its access to TV band database is limited.

Fixed TVBDs may operate on channels 2 to 51, except channels 3, 4, and 37, but cannot operate on the same or the first adjacent channel to a channel used by a TV service. The maximum transmission power of fixed TVBD is 1 W, with at most 6 dBi antenna gain. Hence, the maximum Effective Isotropic Radiated Power (EIRP) is 4 W. Portable TVBDs can operate only on channels 21 to 51, except channel 37, but cannot operate on the same channel used by TV services. The maximum transmission power of portable TVBD is 100 mW, or 40 mW if it is on the first adjacent channel to a channel used by a TV service. Furthermore, if a TVBD device is a sensing-only device, then its transmission power cannot exceed 50 mW. All the TVBDs have strict out-of-band emissions requirements. The antenna (outdoor) height of fixed TVBD must be less than 30 meters, while there is no limitation on the antenna height for portable TVBD.

Careful selection of the frequency of operation and the location of base station nodes is critical when deploying a wireless communication network. In many cases, extensive network planning is required to determine an optimal configuration that provides adequate coverage and capacity, while minimizing the effects of inter-cell interference. Once determined, the BS operates at a fixed location using a fixed frequency allocation. Cellular base stations using LTE and HSPA operate over a fixed frequency allocation and do not change their operating frequencies dynamically.

For networks that make use of Licensed Exempt (LE) bands such as TVWS, there is a need for secondary users to coexist with primary users and/or other secondary users. TVWS or licensed exempt cellular systems need to be highly frequency-agile in order to respond to interference from secondary users or to evacuate promptly in the presence of a Primary user. The presence of secondary users, which can vary with time, will also result in temporal variations in the channel availability and/or quality. Therefore, to facilitate the optimal use (or at least a near-optimal use) of the available spectrum for such deployments, a robust mechanism that can dynamically assign/reassign the frequency of operation for a base station node in response to changes in the localized channel availability and/or quality is desirable.

Described in more detail below are systems and methods for a base station to dynamically allocate and reconfigure cells in a Licensed Exempt spectrum, such as TVWS. The systems and methods include, for example, candidate channel monitoring, active channel monitoring, and seamless channel change. With regard to candidate channel monitoring, this technique may occur at the initialization of the Base Station and after certain events triggering a reconfiguration, where the Base Station registers to a Coexistence Manager and retrieves a channel list and usage information related to a specific LE band from the Coexistence Manager. Based on the information received as well as operator policies, the Base Station initiates a candidate channel monitoring procedure (described in more detail below). In summary, the candidate channel monitoring procedure, in which a Base Station interacts with a Coexistence Manager, selects candidate channels and configures cognitive-sensing capable WTRUs to start inter-frequency measurements to detect and determine secondary user usage and/or primary user usage. WTRUs report primary and secondary usage detection events to the Base Station through new RRC signaling. This procedure includes the definition of various algorithms, which match the measurement/sensing configurations to the channel types(s) being monitored, and can be used for the ranking and selection of the candidate channels. Also described below is a procedure to reconfigure the candidate channel monitoring based on measurement events or new channel usage information received from the Coexistence Manager.

An Active Channel Monitoring procedure may be used to monitor the use of an allocated channel via cognitive sensing as well as other RAT-based measurements. The Active Channel Monitoring may be used to make decisions as to whether or not operation on a given channel should continue. The procedure includes the definition of various algorithms that make use of sensing and RAT based measurement reports to evaluate the availability and quality of the active channels. Exemplary events that could trigger a channel change at the eNB and the WTRUs or a reconfiguration of the measurements and sensing at the eNB as well as at the WTRUs are also provided below.

Methods of Seamless Channel Change enable fast and seamless channel switching in the Licensed Exempt band for a system employing carrier aggregation of Licensed and LE cells. Although these solutions are described herein in the context of LTE-A, they are also applicable to other wireless technologies, such as DC-HSPA operation in the Licensed Exempt band or any Licensed Shared Access environment or, in fact, any network in which spectrum can be shared by different operators. A seamless channel change using a new MAC CE indicating to all WTRUs configured to operate in a given cell that the cell will start operating in a new channel or, in other words, at a new operating frequency, in the near future. All other parameters of the cell may remain the same. The operation on the cell is minimally disrupted, i.e., the WTRU will not reset the MAC or flush its HARQ buffers at switching time. The eNB may order all WTRUs operating on that given cell to move to a new frequency at a given time. The eNB needs to stop transmitting at the previous operating frequency. Through this seamless channel change, the eNB also may order all WTRUs operating on that given cell to reconfigure their measurements and sensing on the new frequency.

In some embodiments, a cell switch to a preconfigured cell using MAC CE typically is signaled to some or all WTRUs. One aspect is the development of a preconfigured cell in the WTRUs and the eNB in which no measurement is performed by the WTRU. Another aspect is the fact that the eNB typically does not operate over preconfigured cells (for coexistence reasons). The existence of the preconfigured cells is transparent to the PHY layer in contrast to configured but deactivated cells. As such, preconfigured cells are not part of the channel set as defined by the Carrier Indicator Field (CIF) in the DCI format. Preconfigured cells, therefore, also are not assigned a specific CellIndex at the RRC Layer. Other signaling alternatives to the new MAC CE may include, for example: 1) a Group based Channel Switch MAC Control Element; 2) an L1 Control Signaling-Based Cell Change Mechanism; and 3) the use of Cross-Carrier Scheduling to Enable Cell Change.

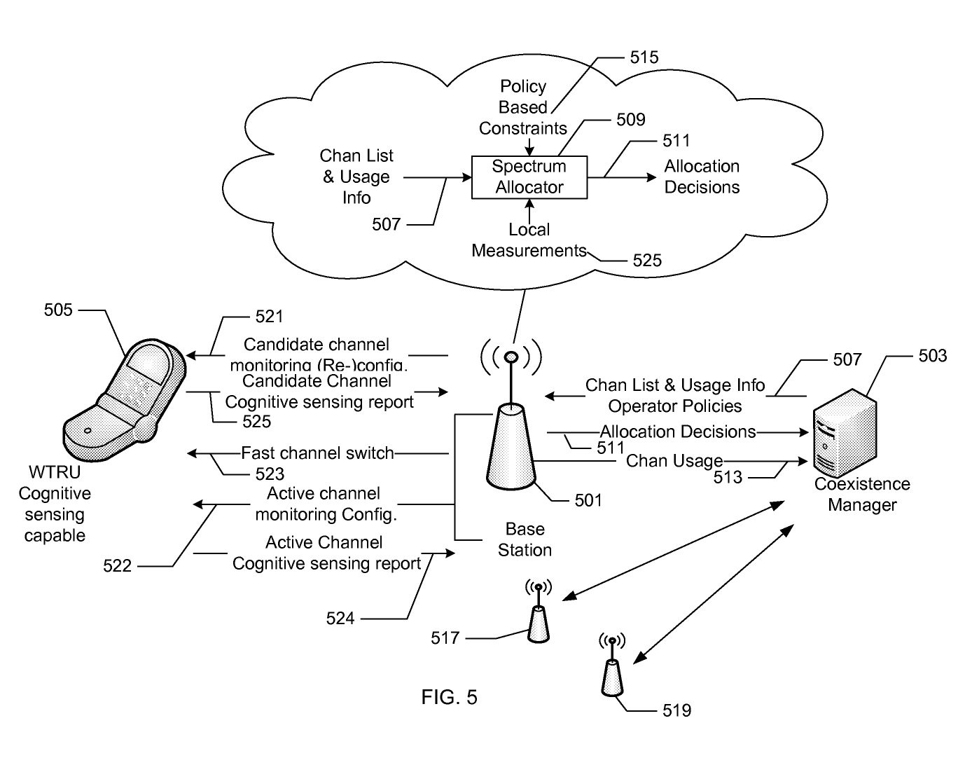

FIG. 5 shows an example system architecture that comprises a Base Station (BS) 501, a centralized Coexistence Manager (CM) 503, and WTRUs 505. The coexistence management system is information based, as it provides the BS 501 with a channel list and usage information as well as operator policies (collectively represented by signal trace 507), but does not make spectrum allocation decisions.

Each BS includes a Spectrum Allocator (SA) 509, that is responsible for making spectrum allocation decisions based on the information 507 provided by the CM 503 and local measurements. Allocation decisions (represented by signal trace 511) made by the SA 509 and utilization metrics (represented by signal trace 513) are provided as feedback to the CM so that up-to-date usage information can be maintained by the CM 503 and shared with other BSs within the network. The CM 503 may optionally include the capability to proactively provide the BS 501 with an update to the provided information in response to changes in allocation decisions and/or other information that is provided to the CM 503 by other BSs, e.g., BSs 517, 519.

The WTRUs (e.g., WTRU 505) operating under the control of the BS 501 are configured with new measurements as well as new inter-frequency measurements to be performed to monitor secondary usage by others and/or detect the arrival of the primary user (such configuration orders represented by signal trace 521). The WTRU's 505 return such local measurements to the BS 501 in a Candidate Channel Cognitive Sensing report 525. The WTRUs also can receive orders to switch from one operating frequency to another based on the Spectrum Allocator's decision (such orders represented by signal trace 523 and discussed in more detail below).

Below is a non-limiting list of example triggers that may result in the CM providing updated information 507 to one or more BSs:
A neighboring BS, e.g., 517 or 519, allocates a channel that was listed in the original channel list sent to BS 501;
The channel usage of one or more channels provided in the original channel list exceeds a given threshold;
The Channel Type of one or more channels provided in the original lists has changed, e.g., the Channel Type changed from Available to PU Assigned; and/or
A channel that was not provided in the original list becomes a potential candidate channel for use by the BS, e.g., the Channel Type changes from PU Assigned to Available, the channel is de-allocated by a neighboring BS, etc.

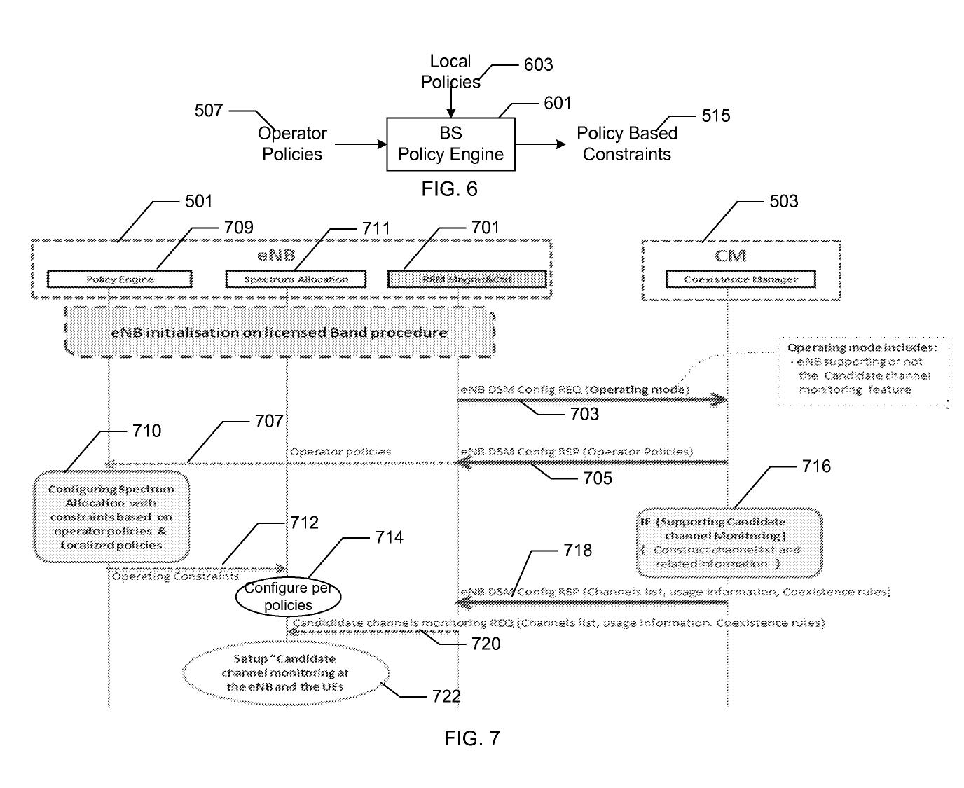

The Policy Based Constraints 515 shown in FIG. 5 can be generated by a BS Policy Engine (FIG. 6). In one embodiment of the invention as shown in FIG. 6, the BS Policy Engine 601 combines the operator policies 507 provided by the CM 503 with localized policies 603 (e.g., stored in memory at the BS) to generate constraints for the SA 509. Localized policies allow the behavior of the SA to be fine-tuned such that channels are allocated in a way that is consistent with the user's requirements. It is noted that policy-based constraints optionally may be generated to control the behavior of other BS functions; e.g. power control, admission control, etc.

### Dynamic Spectrum Allocation

The following sections describe an embodiment of the SA procedures that may be used to enable LTE operation in TVWS channels. At initialization, the SA starts continuous candidate channel monitoring with cognitive sensing. The candidate channel monitoring can be reconfigured in response to different events.

When additional bandwidth is needed, the SA channel allocation procedure is triggered. When the allocated channel(s) is/are activated, the active channel(s) monitoring procedure is configured with cognitive sensing as well as LTE-based measurements. Different events occurring in the system may trigger reconfiguration of the active channel monitoring. When a channel is not needed any more, the channel can be released and the related sensing and measurements can be stopped.

### Candidate Channel Monitoring

A Candidate Channel Monitoring procedure may be used to optimally select a channel that can be used by the BS (e.g., an eNB). This procedure can be executed at initialization of the BS to select the channel(s) of operation. Alternatively, it may be executed periodically or in response to an event (e.g., channel quality degradation, congestion, etc.) to select a more optimal channel for operation or to support the allocation of additional channels to increase capacity.

The Candidate Channel Monitoring procedure generally relies on inputs from the CM 503 and cognitive sensing by the WTRU 505 to continuously verify the channels that can be allocated for use. The channel list 507 provides the eNB with a finite number of potential channels that can be used for operation. The information provided for each channel may include a channel type/category parameter. Different types of sensing methods can be performed for the different channel types. A non-limiting list of exemplary channel types and associated sensing requirements defined for the TVWS domain is described below:
For a channel of type Sub-Licensed, the eNB (and/or WTRU) does not need to sense it, especially if the channel is to be used by a single eNB at a given time.
For a channel of type Available, many secondary users can access it at the same time in the same geographic location. For this channel type, the eNB (and/or WTRU) should perform sensing for Secondary Users (SU). SU sensing should evaluate the Channel Usage of other secondary users and may optionally perform feature detection to identify the RF signal nature of the different Secondary Users (this information could be used for coexistence purposes).
For a channel of type Primary User (PU) Assigned, the eNB (and/or WTRU) is allowed to use it as long as a PU is not detected at the eNB (and/or WTRU). Hence, the eNB (and/or WTRU) should perform sensing for PU detection. Moreover, since other Secondary users may also use this channel, the ENB (and/or WTRU) should also perform SU sensing.

It is noted that when the SA allocates PU Assigned channel type, the eNB can start using it. However, it will only be assigned to a WTRU that has PU sensing capability. Optionally, it may be assigned for a WTRU without PU sensing capabilities, but limited to Downlink only usage.

The SU and PU sensing could be designed according to different approaches. A list of different approaches representing various embodiments of the invention is described below.

In one embodiment, the sensing is performed at the eNB as well as at all the WTRUs (or specific WTRUs that are location representatives) having cognitive sensing capabilities. This approach may be advantageous in a large cell scenario by assuring the absence of a PU and low SU presence (low interference due to SUs) prior to using the channel not only at the eNB location but also at the WTRUs' locations.

In another embodiment, the eNB is considered to be a representative location of the devices it serves. Hence, PU and SU sensing is only applied at the eNB. This approach, on one hand, will not result in increased power consumption at the WTRUs, but may best be reserved for use only in small cell size scenarios.

In yet another embodiment, the sensing for PU and SU is performed only at the eNB for the candidate channels to be monitored before being allocated and used. However, once a channel/supplementary cell is allocated and used (activated), in addition to the eNB, the WTRUs using this channel also perform sensing for PU and SU. Particularly, for uplink usage, the BS will only schedule PU-assigned channels to WTRUs having PU sensing capabilities.

Optionally, channels can be assigned to a WTRU without PU sensing capabilities, but limited to downlink only usage. It is noted that when a supplementary cell is active, LTE-based measurements also are performed. This approach offers scalability advantages in terms of cell sizes. In terms of power consumption, this approach has the advantage of not causing increased power consumption at the WTRUs for monitoring candidate channels, which is not the case when the supplementary cell is activated and used by the terminal devices in the uplink channel. Optionally, sensing at WTRUs could be optimized by performing the sensing only by specific WTRUs that can act as location representatives (assuming that conditions at WTRUs in the same geo-location are well represented by conditions at one of the WTRUs). Hence, WTRUs from a common geo-location can alternate on the sensing role to share power consumption load.

FIG. 7 shows spectrum allocation initialization in accordance with one non-limiting embodiment. For the eNB to operate on TVWS channels, the eNB has to register with the TVWS database. The eNB 501 performs that registration via the CM 503.

At the eNB startup or during operation, the RRM Mgmt. & Control function 701 initiates a request to the CM 503 for TVWS operation configuration. This request is illustrated by the eNB DSM Config REQ message 703, which may include an operating mode parameter to indicate whether the eNB has enabled the background Candidate Channel Monitoring procedure. Upon receiving the eNB DSM Config REQ message 703, the CM 503 will trigger an end-to-end device registration between the eNB and the TVWS database (not shown in FIG. 7).

In some embodiments, the CM may optionally transmit a ranked list of candidate channels, coexistence rules, and/or usage information to the eNB (message 705) if it is capable of processing such information, i.e., if it supports the Candidate Channel Monitoring procedure as described below.

Interactions between entities in the eNB and CM may include the following. First, the CM will transmit operator policies to the eNB policy engine. This may be done through the RRM Mgmt & Ctrl function, as illustrated at 705 and 707. As illustrated at 710, the eNB policy engine 709 will combine the operator policies with eNB localized policies and issue constraints to the Spectrum Allocation entity (SA) 711 to use when selecting/allocating a channel (as illustrated by message 712). The SA 711 is then configured accordingly as illustrated at 714. On the other hand, in some embodiments, all communications with the SA pass through the RRM Mgmt. & Control function.

During operation, the policies may change at the CM 503 (for the operator policies) or at the eNB 501 (for the localized policies). The SA 711 can optionally be informed of these policy changes so they can be applied when making future SA decisions that may result from the execution of the SA procedures, e.g., Candidate Channel Monitoring, Channel Allocation, Active Channel Monitoring.

As illustrated at 716 and message 718, the CM 503 may transmit to the eNB 501 (when the background candidate channel monitoring is enabled) a ranked list of channels with coexistence rules and information. As illustrated by message 720, upon receiving this channel list, the RRM Mgmt & Control function 701 configures the SA 711 to start the background candidate channel monitoring and the SA 711 commences candidate channel monitoring as illustrated at 722.

In some embodiments, the RRM Mgmt. & Control function 701 triggers configuration of the SA 711 for candidate channel monitoring in response to an event that occurs during eNB operation, e.g., detection of network congestion.

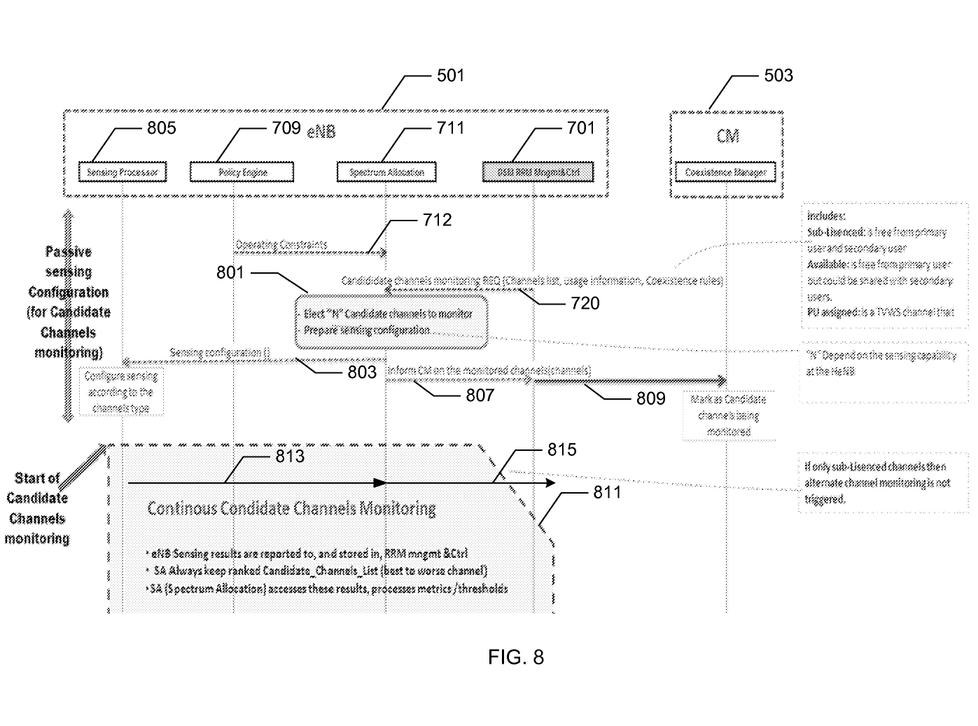

FIG. 8 illustrates details of the setup of the candidate channel monitoring procedure by the SA (corresponding largely to 722 in FIG. 7). As described above in connection with FIG. 7, the SA 711 begins execution of the procedure to set up the candidate channel monitoring after receiving both the policies (message 712 from FIG. 7—reproduced in FIG. 8 for context and clarity) and a request from the RRM Mgmt. & Control function with ranked channels list and coexistence information (message 720 from FIG. 7—reproduced in FIG. 8 for context and clarity). Then, as illustrated at 801 in FIG. 8, the SA 711 applies the policies and the coexistence information to elect N of the channels from the channel list received from the RRM Mgmt. & Control function in aforementioned step 720, where N is a system parameter and depends on the sensing processor capabilities and N is an integer equal to or less than the number of channels in the list.

In one embodiment, an election algorithm prioritizes first channels of the Sub-Licensed channel type, then channels of the Available channel type (assuming its usage is acceptable), and then channels of the PU Assigned channel type. The election algorithm also may consider the allowed transmit power with regard to the cell size (eNB coverage) in selecting and ordering the N elected channels. If the N elected channels are all sublicensed channels, then no sensing is required. Otherwise, as illustrated at 803, the SA configures the sensing processor 805 to trigger cognitive sensing for every channel. Although not shown as such in FIG. 8, in an alternative embodiment, the SA 711 may issue all instructions to the sensing processor 805 via the RRM Mgmt. & Control function 701. Also, as illustrated at 807 and 809, the SA 711 could optionally inform the CM 503, via the RRM Mgmt. & Control function 701, of the N channels elected for monitoring (the ranked list), so the CM could mark these channels as being monitored.

As illustrated at 811, after configuration, the sensing processor 805 performs sensing using different algorithms, depending on the channel type (e.g., SU sensing and/or PU sensing). The sensing processor 805 reports sensing results to the SA 711 (message 813) and the SA further reports those sensing results to the RRM Mgmt. & Control function 701 (message 815). The SA 711 continuously accesses these results and ranks the channels accordingly. In one possible embodiment of a ranking algorithm, the SA assigns priority to channels of the Available channel type (if its Channel Usage is acceptable) and then to channels of the PU-assigned channels type. The algorithm also may consider the allowed transmit power with regard to the cell size (eNB coverage) and the channel usage on the channels.

In some embodiments, when sensing includes feature detection (detection of the type of the technology) by the base station and/or the WTRU's, the ranking algorithm may also consider the type of the SUs present in the channel from the coexistence perspective. Friendly secondary users, e.g., those that sense before transmitting, like Wi-Fi, may be given priority over secondary users that employ technologies that access the channel in non-friendly manners. Also from the sensing results, the SA continuously performs the detection of the primary user's presence (for PU assigned channels) and/or of high channel usage on the candidate channels. If either a PU is detected or high channel usage is detected, the candidate channel monitoring should be reconfigured.

As described above, the SA 711 elects N channels, where N is a system parameter and could depend on the WTRU's cognitive sensing capabilities, which will be used to configure WTRUs with inter-frequency measurements specific to primary user detection and secondary user monitoring. Candidate channel monitoring at the WTRU may be based on configuring connected WTRUs (i.e., WTRUs in RRC Connected mode) with new measurement objects where one measurement object would be required of each of the N monitored channels.

For secondary user monitoring, the measurement object may define one or more specific technologies (e.g. WiFi) for which the WTRU must verify if that specific technology is operating in the channel defined by the measurement object. The measurement object could provide one or more bandwidth sizes that the specific technology may use. The measurement object may also define a specific received power threshold at which the detected technology must be received to meet the criteria of detection as a reporting condition. For example, an event condition could be to report any occurrence of a signal received from any secondary user using a specific technology higher than a specific received power threshold. The sequence of events may follow the following logic:

A measurement object for channel N₁ (one of the N channels) defining monitoring for a secondary user is sent to a cognitive sensing capable WTRU in connected mode through an RRC reconfiguration message. The WTRU receives the RRC message and configures its RRC layer accordingly. The WTRU uses some of the measurement gaps used for inter-frequency measurements or opportunistically in DRX off cycle, to monitor secondary usage in channel N₁.

Feature detection such as WiFi detection can be performed by the WTRU by selecting one of the valid bandwidth sizes defined in the measurement object (i.e. 5 MHz), from which the WTRU can derive a sampling rate and a default modulation scheme, and monitor the presence of WiFi preambles at that sampling rate and modulation scheme. In the event that WiFi preambles are detected, the WTRU would measure the RSSI following the preambles to estimate the received power level of the specific technology. The power level estimate could be averaged over several WiFi detection events.

For primary user detection, a measurement object may provide the WTRU with the set of primary user technologies that need to be detected for this channel. For example, based on information received in the channel list and usage, the eNB may know that only DTV signals need to be detected.

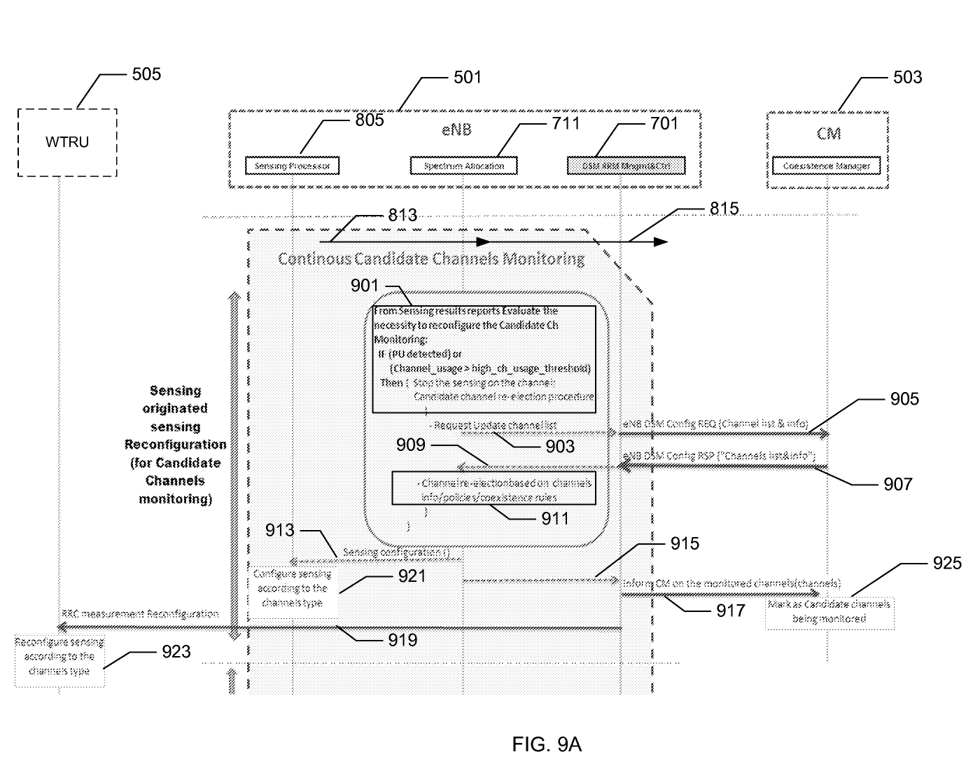

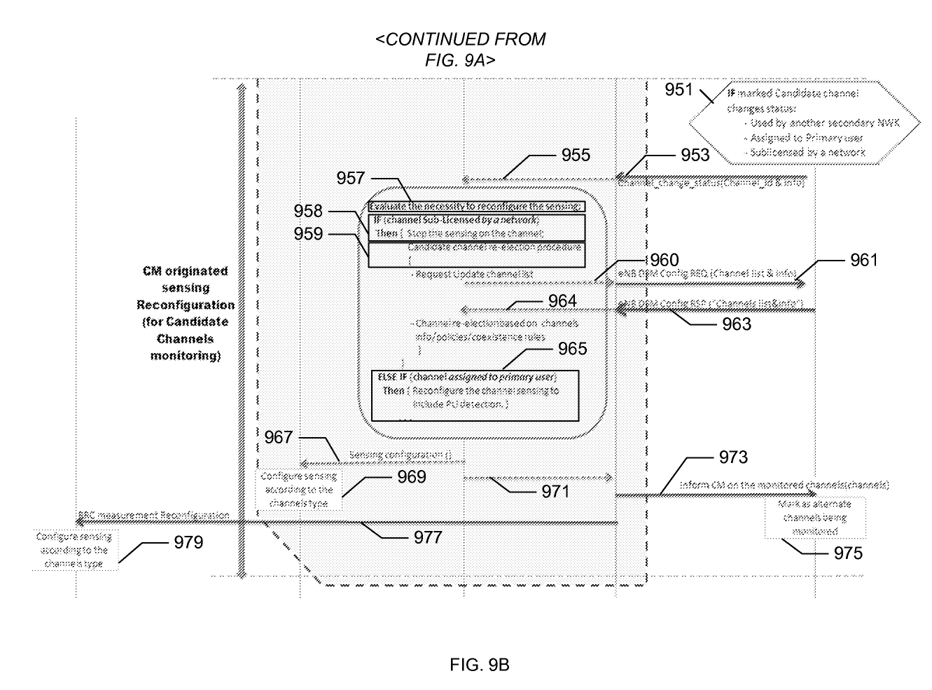

FIGS. 9A-9B illustrate an embodiment of a process for reconfiguration of the Candidate Channels Monitoring procedure responsive to different triggers. The first trigger 901 illustrated in FIG. 9A is based on cognitive sensing results. When the SA 711 detects the presence of a Primary User and/or high channel usage on a channel (via a report message 813 from the sensing processor 805), it starts a candidate channel re-election procedure by requesting from the CM 503 an updated channel list with its accompanying information (coexistence information, measurements information).

In one embodiment, all communications with the CM are handled by the RRM Mgmt & Ctrl function 701. Thus, in such an embodiment of the candidate channel re-election procedure, the SA 711 sends a request 903 to the RRM Mgmt & Ctrl function 701 seeking the updated channel list and other information. The RRM Mgmt & Ctrl function 701 sends a corresponding request 905 to the CM 503. The CM responds to the RRM Mgmt & Ctrl function with the requested info (message 907) and the RRM Mgmt & Ctrl function forwards the results to the SA (message 909). The SA uses the received list and re-elects a new replacement channel (911). Then the SA triggers the reconfiguration of the sensing processor at the eNB, and, if appropriate, at the WTRUs, to stop sensing the channel impacted by the PU and/or the high SU channel usage and to start sensing the new elected channel. More particularly, the SA sends a sensing reconfiguration message 913 to the sensing processor and also sends a sensing reconfiguration message 905 to the RRC Mgmt & Ctrl function for forwarding to the WTRU 505. RRM Mgmt & Ctrl function sends a sensing reconfiguration message 919 to the WTRU 505. The CM also may be informed of the newly formed candidate channels list being monitored at the eNB via optional message 917.

As shown at 921, the sensing processor 805 reconfigures its sensing parameters as dictated by the sensing configuration message 913. As shown at 923, the WTRU 505 also reconfigures its sensing parameters as dictated by the RRC measurement reconfiguration message 919. As shown at 925, the CM 503 updates its list of candidate channels being monitored by the eNB.

Referring now to FIG. 9B, the second trigger type is illustrated at 951 and is based on a channel status change at the CM database. Since, the database is informed of the channels being monitored at the various eNBs, the CM may informs the SAs of the eNBs under its auspices whenever there is a change in a channel's status at the CM database. Every time the SA receives a new channel list from the CM, SA can reform the candidate channel list.

More particularly, referring to FIG. 9B, at 951, the CM 503 detects a change in the status of a channel.

A non-limiting list of example triggers 951 based on a status change is described below.
The monitored candidate channel type becomes Sub-Licensed to another user. In this event, responsive to receiving such information from the CM, the SA will stop monitoring that channel and replace the channel in its list of N channels to monitor by triggering a Candidate Channel Re-Election procedure.
The monitored candidate channel type becomes PU Assigned. In this case, the SA configures the sensing processor to start PU sensing on that channel. Optionally, the SA could also consider replacing that PU assigned channel with a different, available channel using the Candidate Channel Re-Election procedure.
The monitored candidate channel is being used by a Secondary User. In this event, the CM should provide the SA with information on the estimated channel usage and type of SU from a coexistence perspective. The SA may consider replacing the channel through the Candidate Channel Re-Election procedure if the channel usage is too high and the SU is not a friendly coexistent. Alternatively, the SA could ignore this information and rely solely on the SU sensing to measure the actual impact of this new SU at the eNB location.
A new Sub-Licensed channel becomes free for use. In this case, the CM, knowing that the eNB is monitoring available and PU-assigned channels, will inform the SA of the newly sub-licensed channel. The SA will select the lowest ranked channel from its ranked candidate channels list and reconfigure the sensing at the eNB and/or WTRU(s) to stop sensing it. The SA will then include the new channel in its candidate channel list, which will trigger a reconfiguration at the eNB and/or WTRUs to start sensing on the new channel.

In one embodiment, it is assumed that the CM database has the intelligence to supervise the status change of the channels and that it proactively reacts and informs the eNB of any changes. However, in another embodiment, the SA could periodically request an updated channel list from the CM. The SA would then verify if any status change occurred in the monitored candidate channels.

Yet another trigger for candidate channels monitoring reconfiguration may be when one or more of the candidate channels are allocated for use. An active channel monitoring procedure is then configured for these channels.

Referring again to FIG. 9B, the CM 503 sends a channel change status message 953 to the RRM Mgmt & Ctrl function 701, and the RRM Mgmt & Ctrl function forwards the information to the SA (message 955). At 957, the SA determines if the trigger event 951 is one that requires requesting an updated channel list from the CM. Such events may include any of the aforementioned (1) a channel becoming sub-licensed), (2) a channel becoming PU-assigned, (3) a channel being used by a secondary user, and (4) a previously sub-licensed channel becoming free. If so, the SA determines that the channel should be dropped from its candidate channel list and replaced with a new channel. Therefore, it may initiate a candidate channel re-election procedure, as shown at 959. Also note that, if the trigger event is the sub-licensing of a channel by the network, the SA additionally will immediately cease sensing on that channel (958). The ceasing of sensing on a channel is not just for the sub-licensing event). In fact, whenever a channel is dropped from the candidate channel list, the SA will cease sensing that channel.

In one embodiment, the candidate channel re-election procedure starts with the SA 711 sending a request 960 to the RRM Mgmt & Ctrl function 701 seeking an updated channel list and other information. The RRM Mgmt & Ctrl function 701 sends a corresponding request 961 to the CM 503. The CM responds to the RRM Mgmt & Ctrl function with the requested info (message 963) and the RRM Mgmt & Ctrl function forwards the results to the SA (message 964).

If, on the other hand, for example, the trigger event is a new assignment of a channel to a primary user (as illustrated at 965 in FIG. 9), the SA does not necessarily need to obtain an updated channel list from the CM. Rather, the SA may merely reconfigure the channel sensing procedure(s) at the eNB 501 and/or WTRU 505 to start monitoring that channel for usage by the primary user.

In any event, thereafter, the procedure is quite similar to that described above in connection with FIG. 9A. Particularly, the SA triggers the reconfiguration of the sensing processor at the eNB and, if appropriate, the sensing process at the WTRU, to stop sensing the channel impacted by the PU and/or the high SU channel usage and to start sensing the new elected channel by sending a sensing reconfiguration message 967 to the sensing processor and sending a sensing reconfiguration sensing message 971 to the RRC Mgmt & Ctrl function for forwarding to the WTRU 505. RRM Mgmt & Ctrl function sends a sensing reconfiguration message 977 to the WTRU 505. The CM also may be informed of the newly formed candidate channels list being monitored at the eNB via optional message 973.

As shown at 969, the sensing processor 805 reconfigures its sensing parameters as dictated by the sensing configuration message 967. Also, as shown at 979, the WTRU 505 also reconfigures its sensing parameters as dictated by the RRC measurement reconfiguration message 977. As shown at 975, the CM 503 updates its list of candidate channels being monitored by the eNB.

### Active Channel Monitoring

Once a channel is allocated at the eNB and is configured at the terminal devices (such as WTRUs), the RRM Mgmt & Cntrl function starts monitoring the use of this channel not only through cognitive sensing but also through LTE-based measurements, namely Active Channel Monitoring. The cognitive sensing (PU sensing and SU sensing) should be performed at the eNB and possibly also at the WTRUs when the channel is allocated. However, the WTRU LTE-based measurements that probe the quality of the channel are based on actual use of the channel by the WTRU, and, thus, can start only after the channel is configured at the WTRU.

The RRM Mgmt. & Control function continuously processes the sensing and measurement reports of the active channels to evaluate the quality of the channels, to detect high channel usage from other SUs and the presence of PUs. During this active channel management, the RRM Mgmt. & Control function may trigger a reconfiguration of the Active Channel Monitoring at the eNB as well as at the WTRUs or trigger a seamless channel switch procedure that, in turn, will reconfigure the Active Channel Monitoring at the eNB as well as at the WTRUs.

A non-limiting list of example events that could trigger a seamless channel switch procedure and/or reconfiguration of the Active Channel Monitoring are described below.
The CM can inform the eNB of a channel status change, e.g., channel being sub-licensed is assigned to a Primary User for a given period of time. In this case, the RRM Mgmt. & Control function triggers a reconfiguration of the Active Channel Monitoring so that sensing for PU detection is configured at the eNB and/or at WTRUs using the channel.
The detection of a PU can result in different reactions depending on the type of node that detected the PU and/or the extent of the detection (in terms of number of nodes that made the detection). When a small number of WTRUs detect the presence of a PU, the RRM Mgmt. & Control function may instruct the Packet Scheduler to avoid assigning that channel to the WTRUs that detected the PU. The channel is deactivated at these WTRUs for downlink transmissions and the corresponding sensing and measurement may be reconfigured to be released. However, when the detection occurs at the eNB or at a high number of WTRUs, the RRM Mgmt. & Control function may trigger a seamless channel switch procedure.
The detection of SUs and/or an increase in the utilization of the channel by SUs. Depending on the operator/local policies, the RRM Mgmt. & Control function may trigger a seamless channel switch procedure. In some embodiments, the RRM Mgmt. & Control function may attempt to coexist on such a channel when the degradation in performance that is caused by the SUs is tolerable.
From the LTE based measurements reports, if degradation is assessed on specific links (of low number of WTRUs), specialized procedures like Load Balancing, ICIC, etc. may be executed to handle the issue. Optionally, the Packet Scheduler may be instructed to avoid assigning that channel to specific WTRUs. However, if the degradation is detected for a high number of WTRUs and is general to the channel, the RRM Mgmt. & Control function may trigger a seamless channel switch procedure.

From the LTE-based measurements reports, if low usage of a channel is assessed (e.g., the base station has more channels than are needed), the RRM Mgmt & Control function may trigger a channel release procedure to release the channel from being monitored. Thus, in turn, a reconfiguration of the Active Channel Monitoring is conducted to also release all the related sensing and measurements.

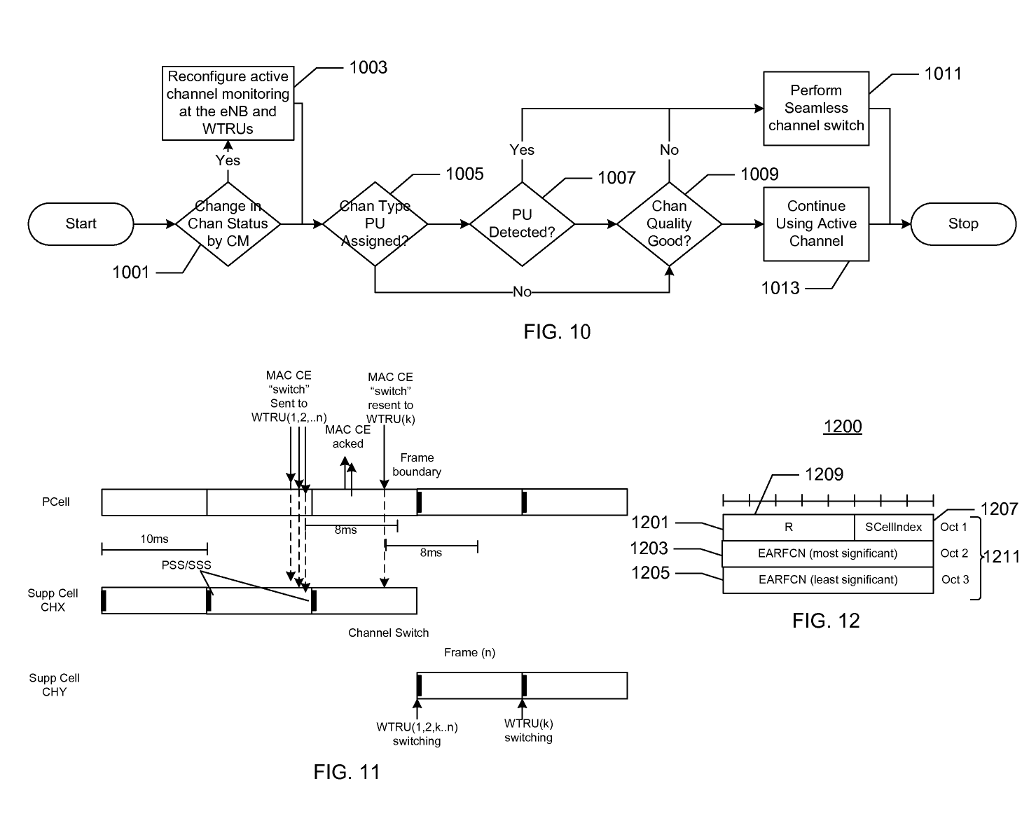

FIG. 10 illustrates an embodiment of an Active Channel Management algorithm. If, at 1001, the RRM Mgmt & Control function receives notification from the CM of a change in channel status, flow proceeds to 1003, in which the RRM Mgmt & Control function reconfigures the active channel monitoring at the eNB and the relevant WTRU(s) if necessary or advisable, such as according to any of the trigger event scenarios described immediately above. As noted therein, in some cases, the RRM Mgmt & Control entity may decide not to perform any reconfiguration. In either event, flow then proceeds to 1005, in which it is determined if it has been detected that a channel has been assigned to a primary user. If so, flow proceeds to 1007, where it is determined if the primary user is actually using the channel. If so, flow proceeds to 1011, where a seamless channel switch (discussed in detail below) is performed to evacuate the channel. If, on the other hand, the channel has not been reassigned to a primary user as determined at 1005 or, if it has, but the active presence of a primary user is not detected at 1007, flow instead proceeds from 1005 or 1007 to 1009, in which it is determined if the channel quality meets a certain threshold. If not, flow proceeds from 1009 to 1011 for the performance of a seamless channel switch. If, on the other hand, channel quality exceeds the threshold, flow instead proceeds from 1009 to 1013, in which the active channel monitoring continues as before.

### Seamless Channel Switching

As part of the active channel monitoring process, the eNB may decide to change the operating frequency of a cell. This could be beneficial in scenarios where a WiFi network starts or resumes operation in the same channel used by the supplementary cell (SuppCell), as the interference level may suddenly become unacceptable for this specific supplementary cell. This is particularly true in the case that WiFi nodes do not defer their transmission when the LTE signal strength received by these WiFi nodes is below −62 dBm, the energy detection threshold. Another scenario may be when a primary user is detected by the eNB, and all transmissions in the current TVWS channel must be stopped. Fortunately, the TVWS band defined by the FCC is large and is comprised of up to 32 equal size channels. Therefore, there is a high likelihood that one or more similar channels are available to switch to. These scenarios point to performance issues impacting the majority of the WTRUs operating in a cell where a change of operating frequency would be beneficial. Systems and methods described below provide seamless channel switching capability, namely seamless channel switching and cell switch to a preconfigured cell.

Referring first to seamless channel switching, this may be performed by indicating to all WTRUs configured for a given cell that the cell will start operating in a new channel (i.e., at a new operating frequency) in the very near future. All other parameters of the cell will remain the same. The operation on the cell will be minimally disrupted, i.e., the WTRU(s) will not reset the MAC(s) or flush the HARQ buffers at switching time. The eNB will order all WTRUs operating on that given cell to move to a new frequency at a given time. The eNB needs to stop transmitting on the previous operating frequency at that time.

In the case of TVWS spectrum, the cell change may be done between two equally sized channels of 6 MHz. As a result, the MAC layer will be able to control the cell change in a way that is initially independent or transparent to the RRC. As a result, when a cell change needs to be performed, the RRC layer of the WTRU will initially be unaware of the switch, and will continue to operate using the same configuration as though the cell change did not occur. The MAC layer, on the other hand, will be able to schedule transport blocks on the modified channel for the SuppCell (in the case of DL), or schedule UL grants to any of the WTRUs using the modified channel for the SuppCell. This avoids the need to send RRC system information to each WTRU in order to initiate the cell change. It results in an overall decrease in cell change latency, which is desirable for operation in the unlicensed band where channel agility of the system and an efficient method for changing the SuppCell is important.

An exemplary logical flow of this embodiment is as follows:
1. The eNB receives the channel change request from the central entity responsible for deciding and allocating bandwidth in the unlicensed band (this could be the eNB itself). The cell change request is assumed to include the new channel in the unlicensed band that the SuppCell should move to, including any additional information needed for the use of this channel by the eNB and the WTRUs. This cell change request is forwarded to the MAC layer, which is responsible for initiating and controlling it.
2. The MAC layer at the eNB receives the cell change request and the critical information about the new channel (carrier frequency, maximum allowable transmit power).
3. The MAC layer at the eNB will create a MAC PDU (Protocol Data Unit) that contains the Channel Switch MAC CE. The Channel Switch MAC CE will contain the critical channel information that was obtained in step 1. The Channel Switch MAC CE will be given priority over the MAC SDUs (Service Data Units) that are currently ready for transmission at the eNB. More details as to how the Channel Switch MAC CE is mapped to the PHY layer as a transport block are provided below.
4. Each WTRU that receives the transport block containing the MAC CE will decode the channel switch at the MAC layer. The MAC layer will then configure the PHY layer (and front-end) to switch to the new channel (as per the channel switch message) at a specific frame/subframe.
5. When a Channel Switch MAC CE is received, the HARQ buffers and other context information currently maintained by the MAC layer are unchanged. For instance, if a WTRU is scheduled to send ACK/NACK in the supplementary UL carrier, and the channel for that supplementary carrier was switched prior to the sending of the ACK/NACK, the WTRU will send the ACK/NACK at the same scheduled subframe, but will do so on the new channel/frequency.
6. If necessary, some limited amount of information related to the channel switch may be passed to the RRC layer to ensure proper functioning of the RRC while being transparent to the channel switch. This could also consist of a translation of information (by the MAC layer) that is exchanged between the MAC and the RRC.
7. RRC Messaging between the WTRU and eNB/HeNB is used to re-synchronize the RRC layers of the eNB/HeNB and the WTRU from the perspective of the SuppCell being used.

In one embodiment, a MAC CE, referred to as channel-switch MAC Control Element, indicates to a WTRU that one of the configured cells is to change operating frequency. The following are example details and rules on the MAC CE-based channel switch procedure in accordance with one non-limiting embodiment. The MAC CE is unicast and uses the WTRU-specific RNTI. An indication of the configured cell to which communications will be switched (referred as switched cell) is included in the Channel Switch MAC CE. The configuration parameters of the switched cell will remain the same. The WTRU will not reset the MAC or flush its HARQ buffers at switching time. The HARQ buffers will be preserved. An indication of the new operating frequency will be included in the Channel Switch MAC CE. As illustrated in FIG. 11, the channel switching will occur at the frame boundary that would follow the reception of the MAC CE plus 8 subframes. The cellID will remain unchanged as a result of the switch. At that point, the eNB and effected WTRU(s) will stop measurements/sensing on the previous channel, flush the RRC measurements, and start new measurements/sensing on the new channel.

Referring now to FIG. 12, which shows the structure of the Channel Switch MAC CE 1200, the channel-switch MAC CE is identified by a MAC PDU sub-header with LCID, as specified in FIG. 12. It has a fixed size and consists of three octets, 1201, 1203, and 1205. The first octet 1201 contains 3 bits 1207 to identify the SCellIndex of the Switching Cell. The other 5 bits 1209 are reserved. The second and the third octets 1203, 1205 represent the new EARFCN 1211. Table 1 shows example values of LCID for DL-SCH.

TABLE 1

| Index | LCID values |
|---|---|
| 00000 | CCCH |
| 00001- | Identity of the logical channel |
| 01010 | |
| 01011- | Reserved |
| 11001 | |
| 11010 | Channel-Switch |
| 11011 | Activation/Deactivation |
| 11100 | WTRU Contention Resolution Identity |
| 11101 | Timing Advance Command |
| 11110 | DRX Command |
| 11111 | Padding |

Since the WTRU will initially have to operate on the new cell without explicitly receiving system information (through RRC signaling) prior to the cell change, the WTRU will initially assume the same system information as the old SuppCell, except for certain key parameters that are provided in the Channel Switch MAC CE 1200. In order for this assumption to be valid, the old and new SuppCell should contain the same value of:

dl-Bandwidth/ul-Bandwidth—Since the unlicensed band (specifically TVWS) will generally be defined through fixed bandwidths, having a fixed bandwidth across all SuppCells is a preferred scenario for deployment;

phich-Config—If PHICH is configured on the SuppCell, the configuration of this PHICH should remain the same (at least initially). This allows the MAC layer to seamlessly move from one SuppCell to another, as the PDCCH is assumed to be identical to the previous cell; and

CQI-ReportConfig—The MAC layer will maintain the same CQI reports over the cell change until the new SuppCell reconfigures the CQI reporting through RRC signaling (following resynchronization of the RRC layers).

Uplink power calculation parameters for PUSCH and PUCCH should remain the same, except that they will be subject to (or scaled by) a maximum power that is specified in the Channel Switch MAC CE. Certain system information configured by RRC and which is applicable to the behavior on the SuppCells does not need to be changed at the cell change. This is the case, for example, with measurement configuration. Rather than stop or reset measurements being performed at the RRC of the WTRU, the WTRU is allowed to continue measurement on the SuppCell both before and after the cell change. The RCC may flush L3 measurements collected on the previous channel. The RRC layer (and RRM) at the eNB/HeNB, after it is informed of the channel change which occurred at a specific time in the past, will consequently ignore all measurements received from the WTRUs following the channel change for the purposes of RRM and SuppCell selection. Once the RRC Layer has been resynchronized, and any measurement reconfiguration has taken place, the eNB/HeNB can start to reconsider measurements that come from the WTRU. The main idea is that the RRC will operate without knowledge of the channel change for a short period of time, and will then be informed of the channel change later and the exact time when the change took place. Measurements can then be adjusted or reconsidered based on this information.

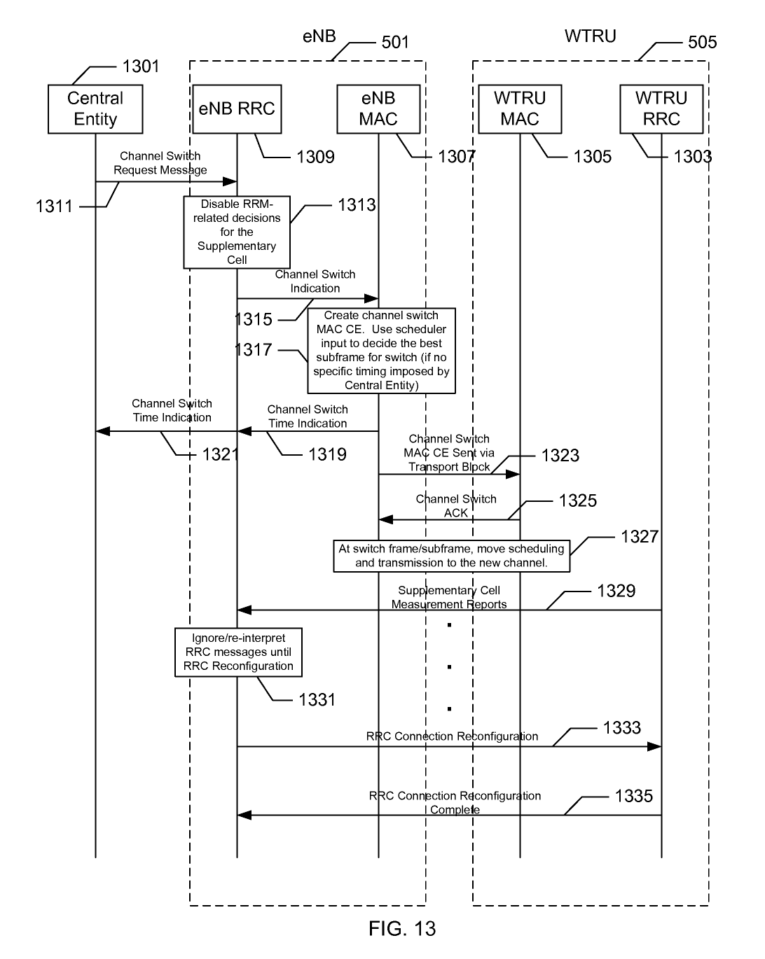

FIG. 13 illustrates an example logical flow of events involved in the MAC Layer Initiated channel change. In particular, the consideration for measurements configured in the SuppCell is illustrated. A central entity 1301 responsible for deciding and allocating bandwidth in the unlicensed bands (e.g., the spectrum allocation) sends a channel switch request message 1311 to the eNB 501, and particularly to the eNB RRC 1309. The channel switch request message 1311 discloses the new channel in the unlicensed band that the SuppCell should move to, including any additional information needed for the use of this channel by the effected eNB and WTRUs. In response, the RRC disables the RRM activities relating to the old SuppCell. The RRC 1309 forwards the channel switch request to the MAC layer 1307 (message 1315). In response, the MAC 1307 creates a corresponding MAC PDU containing a suitable Channel Switch MAC CE, as shown at 1317. The channel switch Mac CE will be given priority over the MAC STU that are currently ready for transmission at the eNB. The Mac 1307 then sends a channel switch time indication message 1319 to the RRC 1309 disclosing the frame at which the switch over is to occur. As shown at 1321, the RRC forwards the message to the central entity 1301. As shown at 1323, the MAC also sends the Channel Switch MAC CE to the WTRU MAC layer 1305 via a Transport Block. As previously mentioned, each WTRU that receives the Transport Block will decode the channel switch at the MAC layer and the MAC layer will configured the PHY layer (and front-end) to switch to the new channel for the SuppCell at the specified frame/subframe. The WTRU MAC 1305 returns a channel switch ACK message 1325 to the eNB MAC 1307.

When a Channel Switch MAC CE is received, the HARQ buffers and other context information currently maintained by the MAC layer remain unchanged. For instance, if a WTRU is scheduled to send ACK/NACK in the supplementary UL carrier, and the channel for that supplementary carrier was switched prior to the sending of the ACK/NACK, the WTRU will send the ACK/NACK at the same scheduled subframe, but will do so on the new channel/frequency. If necessary, some limited amount of information related to the channel switch may be passed to the RRC layer to ensure proper functioning of the RRC while being transparent to the channel switch. This could also consist of a translation of information (by the MAC layer) that is exchanged between the MAC and the RRC.

As shown at 1327 in FIG. 13, at the designated switching frame/subframe, the scheduling and transmission are switched over to the new channel. Thereafter, RRC layer messaging between the WTRU and eNB is used to re-synchronize the RRC layers of the eNB/HeNB and the WTRU from the perspective of the SuppCell being used. More particularly, the WTRU RRC 1303 sends supplementary cell measurement reports 1329 to the eNB RRC 1309. As previously mentioned, the eNB RRC layer 1309 (and RRM) ignores all measurements received from the WTRUs following the channel change for the purposes of RRM and SuppCell selection, as shown at 1331. The eNB RRC 1309 then sends an RRC Connection Reconfiguration message 1333 to the WTRU RRC 1303. After the WTRU RRC 1303 executes the necessary reconfiguration, it sends an RRC Connection Reconfiguration Complete message 1335 back to the eNB RRC 1309. Once the RRC layer has been resynchronized, and any measurement reconfiguration has taken place, the eNB can start to again consider measurements received from the WTRU.

The mapping of certain control channels (e.g., PCFICH) to resource elements depends on the physical cell ID of the cell transmitting these control channels. It may be possible that the SuppCell will also define these control channels based on the cell ID of the SuppCell. There are two scenarios that can occur in the case of a SuppCell change or a channel switch. First, the SuppCell operating in the new channel has a different cell ID, and this change of the cell ID needs to be communicated to the WTRU. The Channel Switch MAC CE will contain the new PHY Cell ID, so that the transition to the new location of these control channels occurs immediately at the frame or subframe that the Channel Switch MAC CE applies to. Second, the channel switch may occur without the need to change the cell ID. For instance, if the SuppCell being used by the WTRU is actually turned off on channel x and turned back on in channel y, the physical cell ID may likely remain the same.

The contents of the Channel Switch MAC CE and the corresponding acknowledgement for the case where the cell ID also is changing, and which the system may also require transmission of by the WTRU, are shown in Table 2 and Table 3 below, respectively. The Channel Switch MAC CE structure of Table 2 is an alternative to that shown in FIG. 12. It may be used only for situations in which the cell ID is changing. However, alternately, in order to use a single consistent Channel Switch MAC CE structure, the structure of Table 2 may be used instead of that shown in FIG. 12 in all cases, even when there is no cell ID change.

TABLE 2

| | | | | | |
|---|---|---|---|---|---|
| Carrier | Target Channel | Max. | Frame | New | Additional |
| Indicator | Number | Power | and/or | Cell ID | Fields |
| Field (CIF) | (or carrier | | Subframe | | |
| | frequency) | | Number | | |

TABLE 3

| | |
|---|---|
| Success or Error | Additional Fields |
| Code | |

Carrier Indicator Field (CIF):

This identifies the supplementary carrier that will undergo the channel switch. Particularly, each bit in the CIF represents a carrier (and we assume that each carrier is on a different channel). Hence, a change in a bit in the CIF identifies the supplemental carrier that will undergo the channel switch. This field could correspond to the CIF defined in LTE Rel-10, or could be a similar value that is used by the WTRU to identify a specific supplementary carrier when multiple supplementary carriers are involved in the aggregation with the unlicensed bands.

Target Channel Number:

This field identifies the new channel in the unlicensed band to which the cell will be switched. The identification could be made through a one-to-one mapping between a specific channel and a channel number (as in the case of the TVWS spectrum) or by similar means. The TargetChannelNumber implicitly specifies the CarrierFreq to be used for the new channel (as per TS 36.331).

Max Power:

This field specifies the maximum power at which a WTRU can transmit on the new channel. It may be based, for example, on regulatory requirements for utilizing that channel. The maximum power may be specified through a tabular means, as is the case with the power headroom MAC CE in TS 36.300.

Frame and/or Subframe Number:

This field contains the SFN (and potentially subframe number) where the switch should take effect. In other words, at this frame number, all WTRUs should stop receiving on channel x and start receiving on channel y. Any uplink allocations or persistent downlink allocations that were associated with the old channel are now applied to the new channel as of this frame/subframe number.

New Cell ID:

Indicates the physical Cell ID of the new SuppCell. This cell ID may or may not be the same as the SuppCell ID being used prior to the channel switch.

In accordance with various embodiments, a cell switch to a preconfigured cell using MAC CE typically is signaled to some or all WTRUs configured to operate in a given cell. Notable aspects of the systems and methods described herein include the development of a preconfigured cell in which no measurement is performed by the WTRU and the fact that the eNBs typically do not operate over preconfigured cells (for coexistence reasons). The existence of the preconfigured cells is transparent to the PHY layer (in contrast to configured but deactivated secondary cells, which are visible to the PHY layer). As such, preconfigured cells are not part of the channel set as defined by the Carrier Indicator Field (CIF) in the DCI format. They are also, therefore, not assigned a specific CellIndex at the RRC Layer. Only at switching time, when a preconfigured cell replaces a configured cell, can the cell be represented in the Carrier Indicator Field (CIF).

Since measurements that are used to decide to switch to another channel can be made outside of the WTRU (e.g., by another WTRU), a preconfigured SuppCell does not require the WTRU that is aware of it to monitor the channel. Secondly, in contrast to an Activation/Deactivation MAC Control Element, when a Channel Switch MAC Control Element is received, the HARQ buffers and other context information stored for the SuppCell are kept and are transferred to the new SuppCell. As a result, some RRC configuration parameters for the old SuppCell and the new SuppCell must be the same in order for the eNB/HeNB to be able to perform a cell change or channel switch between the two channels (e.g., the TDD UL/DL configuration must be the same for the SuppCell in a TDD system).

The contents of a typical RRC pre-configuration message (or information element) are shown below. The message is an exhaustive list of all potential SuppCells that can be later activated by a Channel Switch MAC CE message. The parameter maxSuppCell is limited by the number of channels available in the unlicensed band, and the potential frequency configurations supported by the eNB/HeNB. In addition, the configuration for a particular cell could also be derived from that of another cell. For instance, the pre-configuration of cell y could consist of the same information as cell x, except for certain key fields such as the ARFCN, phySuppCellD, and the SuppCellIndex.

RRC_Preconfiguration := SEQUENCE (SIZE (1..maxSuppCell)) OF
SuppCellToPreConfigure
SuppCellToPreConfigure ::= SEQUENCE {
SuppCellIndex SuppCellIndex,

| | |
|---|---|
| CellIndentification | SEQUENCE { |
| phySuppCellID | phySuppCellID, |
| dl-CarrierFreq | ARFCN |

```
    }
    suppCellradioResourceConfigCommon
    RadioResourceConfigCommon
    suppCellradioResourceConfigDedicated
    RadioResourceConfigDedicated
}
```

An example logical flow in accordance with one embodiment is as follows:
1. The RRC pre-configures all potentially usable channels in the unlicensed band as preconfigured SuppCells. The usable channels may be communicated to the RRC from information contained in the TVWS database, for example.
2. One or more preconfigured (and non-activated) SuppCells are chosen as alternatives to a currently active SuppCell (SuppCell). This decision may be made based on channel proximity or availability, for example. It may also be based on similarity of the channel characteristics (e.g. bandwidth or maximum transmit power).
3. An RRC configuration message may be sent to re-configure the chosen preconfigured SuppCell (say SuppCell2) so that context related configuration parameters (e.g. TDD UL/DL configuration) are set identical to SuppCell. This step can be performed multiple times prior to any cell change (for example, each time the RRC configuration of an active SuppCell is changed, the same change is applied to certain parameters of the preconfigured SuppCells that are to serve as alternatives).
4. The RRC layer at the eNB/HeNB is notified of the need to change the channel by the upper layers. This notification is then sent to the MAC layer.
5. A Channel Switch MAC Control Element would be sent to the WTRU indicating to the WTRU to deactivate and release a SuppCell (e.g. SuppCell) and configure and possibly activate a SuppCell from the preconfigured cells as defined in step 1 (e.g., SuppCell2).
6. Potentially, the WTRU sends a Channel Switch ACK MAC CE in response to the Channel Switch message.
7. The MAC layer of the WTRU informs the RRC layer of the cell change.

Potential formats of the channel switch MAC CE and the Channel Switch MAC CE ACK are shown below in Table 4 and Table 5. Since the number of channels in the unlicensed band can be significantly larger than the number of component carriers (CCs) allowable in LTE Rel-10, the channel switch MAC CE is quite different from the activation/deactivation MAC CE.

During the channel switch, a WTRU identifies the cell to change to based on the Supplementary Cell index, which is a unique identifier for each of the preconfigured cells. The Supp Cell Index is provided for each of the preconfigured cells as part of the RRC_Preconfiguration Message.

TABLE 4

| | | | |
|---|---|---|---|
| Old Supp Cell | New SuppCell | Frame and/or | Additional |
| Index | Index | Subframe Number | Fields |

TABLE 5

| | |
|---|---|
| Success or Error | Additional Fields |
| Code | |

The specific configuration for the new SuppCell was provided initially when the RRC preconfigured that SuppCell. This configuration includes parameters such as the channel frequency, maximum transmit power for the specific channel, TDD UL/DL configuration, etc. As a result, when the MAC layer of any WTRU receives the Channel Switch MAC CE, it begins operating on the configuration associated with the Supp Cell ID received in the above message. The actual timing when the switch takes place is specified by the frame and/or subframe field. Here, an SFN and, optionally, a subframe can be specified in which the WTRU ceases to receive transport blocks from the old SuppCell and begins to receive them from the new SuppCell. Additional fields may be included depending on the value of the New SuppCell ID. Cases where such additional fields are required are described below (e.g., the case of licensed band fallback).

In the acknowledgement, a success or error code may be transmitted in order to indicate to the eNB whether the WTRU was able to perform the channel switch at the specified subframe. Additional fields related to specific error codes may also be sent by the WTRU.

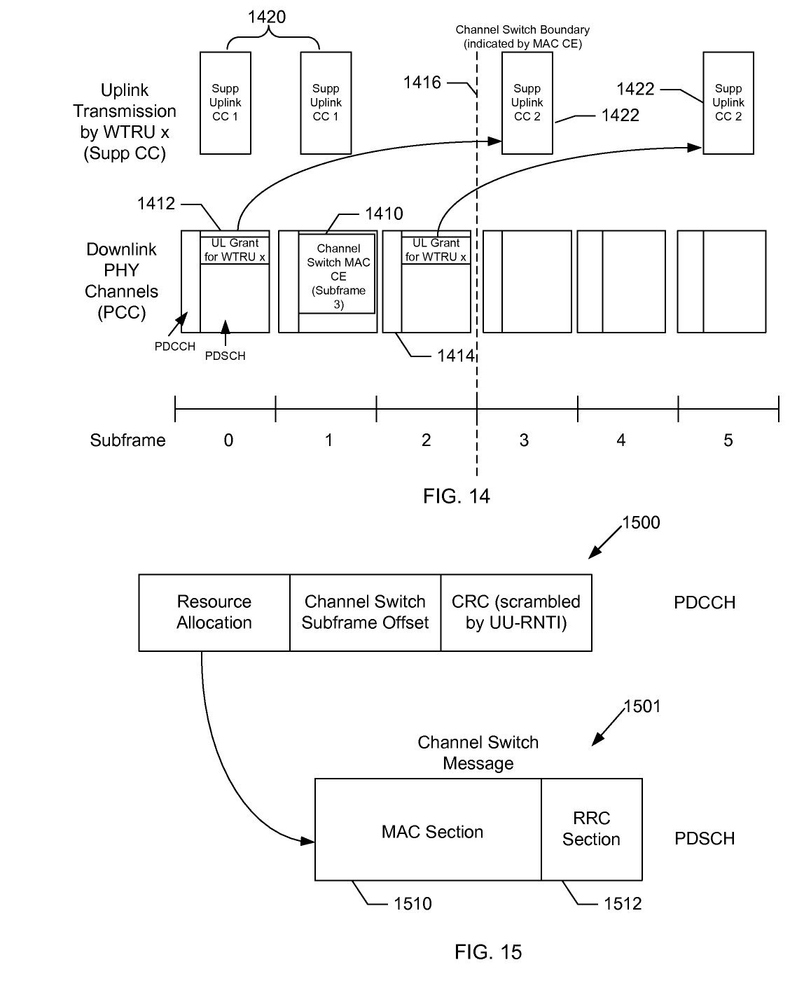

Because the frame/subframe number in which the switch should take place is specified, allocation operations can continue across the switch boundary. This is shown in the timing diagram of FIG. 14, which shows an example of how pending UL grants are handled following the reception by the WTRU of a channel switch MAC CE 1410 (assuming the system does not use the channel switch ACK).

In the above example, because all context information from the old supplementary uplink CC is carried over to the new supplementary uplink CC 1422, the uplink grants 1412 and 1414 made in subframes 0 and 2, respectively, remain valid after the cell change occurs at 1416. The uplink data is sent by WTRU x over the new supplementary uplink CC 1422 in subframes 3 and 5, as was initially scheduled.

A similar approach is taken for allocation of ACK/NACK resources on the PHICH channel. For instance, if a WTRU expects ACK/NACK to be received on Supp downlink CC 1 (in a specific PHICH channel) at subframe 3, but a channel switch is received at subframe 1, the ACK/NACK will be received on the same PHICH channel, but on Supp Uplink CC 2 instead.

As an alternative to unicast MAC CE, the following procedures may signal a seamless channel switch, whether it is for Seamless Channel Switch or Cell Switch to a preconfigured SuppCell. The signaling includes the following: Group based Channel Switch MAC Control Element; L1 Control Signaling-Based Cell Change Mechanism; and use of Cross-Carrier Scheduling to Enable Cell Change.

### Group-based Channel Switch MAC Control Element

Regardless of the approach used to perform seamless channel switching using the MAC CE, there may be a need to send a single MAC CE to potentially multiple WTRUs that are simultaneously making use of the supplementary carrier in either UL or DL (or both for TDD operation). In order to do this, the concept of a group-based Channel Switch MAC CE is introduced.

The presence of a group-based Channel Switch MAC CE is indicated to the PHY in the transport format indicator (TFI) that accompanies the transport block. Upon receiving this information from the MAC, scheduling of the transport block by the PHY is performed in order for multiple WTRUs to receive and decode the same transport block. This can be achieved by introducing a new Radio Network Temporary Identifier (RNTI), herein termed the Unlicensed Usage RNTI (UU-RNTI).

Prior to usage of any unlicensed channels as SuppCells, the WTRU will be assigned one or more specific UU-RNTIs. A common UU-RNTI will be associated with multiple WTRUs that utilize the same SuppCell or set of SuppCells. This association can be done by RRC through system information when the SuppCell is configured. The association may also be updated through RRC messaging to allow dynamically changing the set of WTRUs that is associated with a specific UU-RNTI. For instance, the eNB would preferably maintain a single UU-RNTI for the set of WTRUs that use a SuppCell. This UU-RNTI may be assigned when the SuppCell is first configured for a particular WTRU. Alternatively, the eNB could assign a subset of users using a SuppCell to another UU-RNTI based on the geographical location of these WTRUs. In the case where the SuppCell becomes unusable only for that geographical area, the Channel Switch MAC CE could address only those WTRUs where the SuppCell is unusable. The potential of having a single WTRU assigned to multiple UU-RNTIs allows the WTRU to switch channels under different conditions or to support multiple SuppCells from the eNB with the potential to switch channels on a single one of these SuppCells at any given time.

When sending a transport block that contains a Channel Switch MAC CE message, the PHY will address the resources allocated for the transport block to the UU-RNTI on the PDCCH. The addressing may be done in either the common search space or the dedicated search space.

In order to ensure robustness in the case where the system does not utilize a Channel Switch MAC CE ACK, the Channel Switch MAC CE may be scheduled by the MAC layer to be sent over the licensed band. This can be sent on either the PCell and/or SCell that may be configured on the licensed band as well. In addition, the PHY layer may use additional techniques in order to send the transport block associated with the Channel Switch MAC CE reliably. For example, a larger coding rate and lower-order modulation scheme is expected for a transport block associated with a Channel Switch MAC CE. Certain rules to exploit frequency diversity of resource elements on the PDSCH (such as allocation using resource elements distributed at different ends of the PCell or SCell bandwidth) may also be used to ensure robustness when sending the Channel Switch MAC CE. These methods for robust transmission are not necessary (but still beneficial) when the system employs a Channel Switch MAC CE ACK, as described earlier.

The group-based Channel Switch MAC CE also may be used as a mechanism to signal all WTRUs using the unlicensed band that a particular SuppCell has become unavailable and that the WTRU should fall back to a licensed cell (PCell or potentially SCell). This may also be done using the same group-based Channel Switch MAC CE, using a special or reserved value for the new SuppCell field (example, using a special value for the first n bits of the field). In this case, pre-scheduled resources (such as UL grants that take effect after the subframe boundary specified by the channel switch boundary) need to be either cancelled or moved to a licensed carrier instead. In the case where information from the scheduler regarding resources on the licensed bands is available and the resources in the target subframe are available, a NewSuppCellID field could be used to indicate the cell on the licensed band (e.g. PCell or SCell) where the same resource should be used. The option of using the same resources may be indicated as part of the additional information field.

Alternately to carrying over resources from the SuppCell to the licensed cell during the fallback procedure, the NewSuppCellID could indicate that any pending UL grants are cancelled following the frame/subframe number indicated by the Channel Switch MAC CE. This avoids the need to obtain information about resources from the scheduler at the time the Channel Switch MAC CE is created. This may also be done by ensuring that the delay between the time the Channel Switch MAC CE is sent and when it takes effect is larger than a certain number of subframes and no further UL grants on the old SuppCell are transmitted following the transmission of the Channel Switch MAC CE.

### L1 Control Signaling-Based Cell Change Mechanism

Similar processes as described above with respect to the Channel-Switch MAC CE may be applied to enable the cell change at the PHY layer instead of the MAC layer. PHY layer control signaling to trigger the cell change may be used in both cell changes using a MAC CE following RRC pre-configuration and cell changes initiated by the MAC layer. In what follows, an embodiment of PHY layer control signaling to trigger the cell change in Case 1 (i.e. cells preconfigured by RRC) is described.

In this method, a DCI (Downlink Control Information) dedicated for cell change is utilized. This DCI (sent in subframe n) can initiate a cell change in the immediate subsequent subframe (n+1), or (as was the case in the MAC CE) can indicate the subframe number where the switch will take place. One way to indicate this is to indicate an offset in subframes from the subframe that carries the channel switch DCI. The channel switch DCI may be defined by a new DCI format. Also, a modified version of DCI format 1C (used for the transmission of system information) may be used for the channel switch DCI format.

The channel switch DCI will be placed in the common search space to allow multiple WTRUs to receive it. In addition, since the cell change could take place as little as one subframe following the current subframe, the channel switch DCI format should have a compact message size. Other properties specific to the channel switch DCI format are: use of only QPSK for the modulation scheme associated with the data; no support for HARQ, since this message is unacknowledged; and scrambling using an RNTI that is common to multiple WTRUs that should receive the channel switch message. The SI-RNTI could be used in this case. Alternatively, if the cell change applies only to a subset of WTRUs, a new RNTI may be defined (e.g., the UU-RNTI defined herein). The RRC is responsible for associating a set of WTRUs with a given UU-RNTI.

In one embodiment, the Channel Switch Message is sent over the Primary Cell. However, in other embodiments, the Channel Switch MAC CE is sent over the secondary cell or SuppCell.

FIG. 15 shows an exemplary format for the Channel Switch DCI 1500. Alternately, the format of FIG. 15 can be used in an existing DCI or, instead of the format of FIG. 15, the Channel Switch DCI can use an existing format and the associated channel switch message 1501 that the allocation points to in the PDSCH.

The contents of the allocated message associated with the Channel Switch DCI format (on the PDSCH) may be divided into MAC and RRC sections, respectively. These sections may contain, respectively, the RRC- and MAC-specific information related to the cell change. The size of each section could be encoded in the resource allocation field of the channel switch DCI. The RRC section may contain: New Physical Cell ID and New Measurement Configuration associated with the new SuppCell. The MAC section may contain: New Physical CellID; HARQ related information (if required), such as the behavior to take and HARQ process handling in the case of a licensed band fallback; dl-Carrier Frequency and bandwidth associated with the new SuppCell (and associated CIF); ul-CarrierFrequency and bandwidth associated with the new SuppCell; New PHICH configuration; New uplink power related parameters (which traditionally are set by RRC); and modifications based on the maximum power that can be transmitted over the new LE channel.

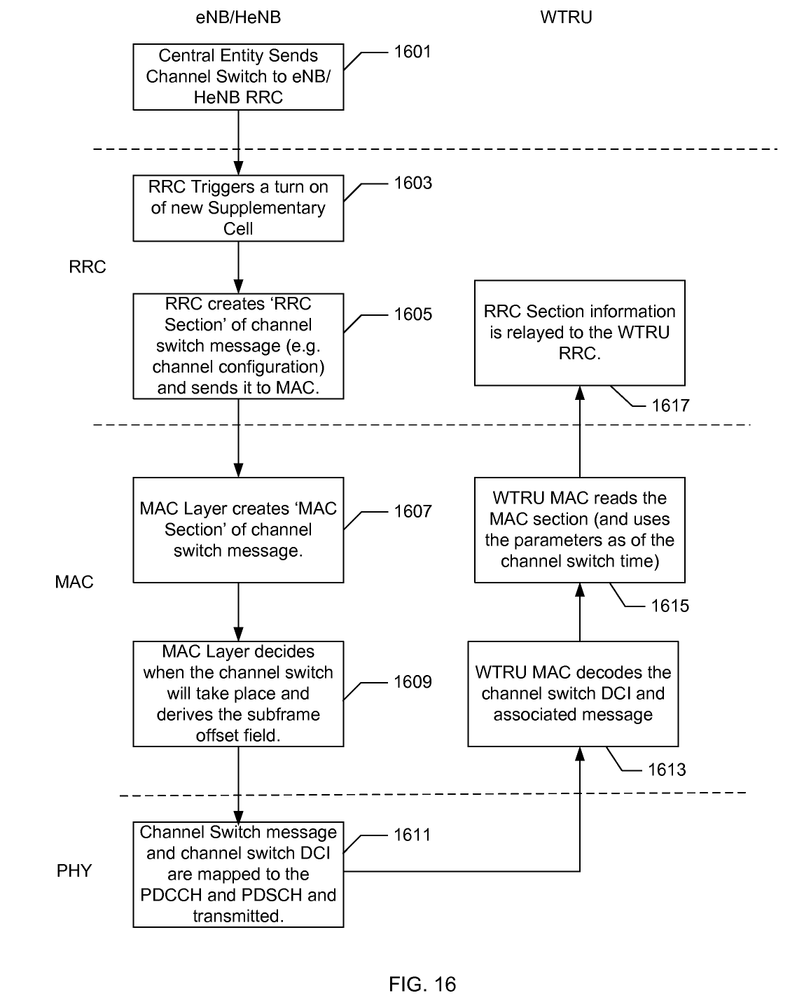

FIG. 16 shows an exemplary sequence of events related to a cell change enabled through L1 control messaging. After being notified of the cell change at 1601, the RRC of the eNB triggers a turn on of the new SuppCell (1603) and creates the RRC portion of the channel switch message and sends information to the MAC layer related to the new SuppCell (if that information is not already available at the MAC) (1605). The MAC will use that information to create the MAC portion of the channel switch message (1607). If the cell change requires the eNB to physically turn on a new cell at the new carrier frequency, this operation is done at this point also.

The MAC layer also decides when the channel switch will take place and derives the subframe offset field (1609). The channel switch is allocated to a set of resource blocks, and the associated channel switch DCI format is mapped to the PDCCH and PDSCH and transmitted to the affected WTRU(s).

At the WTRU, the MAC and RRC interpret the corresponding portions of the channel switch message (1613). Particularly, the WTRU MAC reads the MAC section of the channel switch message and begins using the designated parameters as of the channel switch time (1615). For instance, the MAC layer may apply the new PhyCellID (and configurations for the control channel) to locate any control channels on the Supplementary Carrier. The WTRU MAC layer then relays the RRC section information to the WTRU RRC layer (1617). The RRC will reconfigure measurements to be performed on the SuppCell.

### Use of Cross-Carrier Scheduling to Enable Cell Change

A cell change can be enabled without the need for signaling at the time of switch. This can be done through the use of cross-carrier scheduling from the PCell/SCell only.

If it is assumed that the SuppCell will not use any downlink or uplink control channel (only PUSCH and PDSCH will be carried on the SuppCell), activation or deactivation of the SuppCell from the WTRU perspective is not required. As a result, in this method, a switch from one cell to another in the LE bands may be implicitly made through the use of cross-carrier scheduling. When a specific LE channel is no longer usable, the eNB will stop scheduling resources (uplink or downlink) on the component carrier associated with that particular channel and schedule resources on a component carrier located on a different LE channel. As a result, MAC activation/deactivation is not needed to enable the cell change in the WTRU.

In order to enable this switching method, the WTRU should be aware of all potential channels in the LE bands that the eNB could eventually switch to using cross-carrier scheduling. Effectively, each of these channels represents a component carrier that is assumed active from a Rel-10 perspective (cross-carrier scheduling to any of these component carriers can be done at any time by referencing the appropriate CIF in the PDCCH message that performs the cross-carrier scheduling).

It may be assumed that some time period is required for the WTRU to move from one channel to another channel following a channel switch through cross-carrier scheduling (to be able to start buffering data on the supplementary carrier following decoding of the PDCCH, for instance). As a result, during the channel switch, when the PDCCH carrying the DL assignment is transmitted on the PCC/SCC (Primary Component Carrier/Secondary Component Carrier) in subframe n, the PDSCH carrying the data on the new supplementary carrier is transmitted in the subframe n+1 or n+k (where k>0). This rule is applicable only for the first allocation made to the new supplementary carrier. After this first allocation, the normal timing for downlink allocation in LTE is applied.

In order to determine when the first allocation made to a supplementary carrier for a specific WTRU is (and hence to define when the WTRU assumes a delay of k between PDCCH and PDSCH), the following method and procedure based on a CIF vector maintained by each WTRU may be used. Each WTRU will maintain a vector of CIF values that have been referenced by the eNB through a downlink grant or uplink allocation in the recent past since the configuration or reconfiguration of the supplementary cells by RRC. In the downlink, the WTRU will be prepared to decode data only on the supplementary cells that correspond to a CIF that is currently in the WTRU's CIF vector. Based on the contents of the CIF vector, allocations on the PDCCH will be decoded either with zero delay (i.e. the PDSCH data is assumed present on the supplementary carrier at the same time as the PDCCH allocation) or with a delay of k (i.e. the PDSCH data will be present k subframes following the PDCCH allocation). The following procedure is assumed.

At initial startup, or following configuration or reconfiguration of the supplementary cells by the eNB/HeNB, the WTRU uses an empty CIF vector. A non-empty CIF vector is also possible, assuming the WTRU is sent the initial contents of the CIF vector by the eNB through dedicated signaling.

When an allocation is made to the WTRU for a specific supplementary cell corresponding to CIFx, and CIFx is not currently an element of the CIF vector for that WTRU, the WTRU assumes that the PDSCH data on the supplementary cell will be present k subframes following the PDCCH allocation. At that point, the WTRU adds CIFx to the CIF vector.

When an allocation is made using a CIF value that is currently part of the WTRUs CIF vector, the WTRU assumes that the PDSCH data on the supplementary cell is present at the same subframe as the PDCCH allocation.

The CIF vector can be assumed to be less than or equal to the number of channels in the LE bands. In the case where the CIF vector is smaller, provisions must be made to remove a Supplementary Cell from the CIF vector in certain cases. A non-limiting list of mechanisms that may be used individually or in combination to remove a supplementary cell from the CIF vector include:
The WTRU may remove a supplementary cell from the CIF vector when the CIF vector has currently reached its maximum number of elements, and a new CIF needs to be inserted because the WTRU has scheduled resources on a new CIF that is currently not present in the CIF vector. In this case, another element on the CIF vector is removed using some specific rules, such as the removing the supplementary cell that has received the least recent allocation from the eNB;
The WTRU may remove a supplementary cell from the CIF vector after a certain number of subframes (known by the WTRU and the eNB through system information) has elapsed without an allocation made to that supplementary cell; and/or
The eNB may explicitly request removal of a supplementary cell from the CIF vector by dedicated RRC signaling or MAC layer signaling.

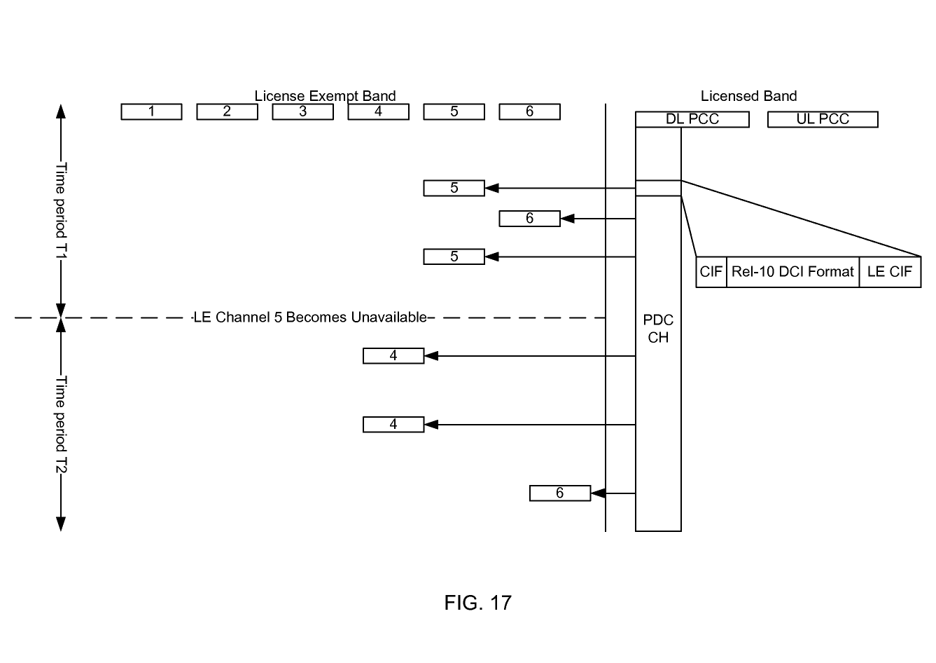

In order to be able to address a potentially large set of LE channels (which could each comprise supplementary carriers at any instant of time), the DCI formats used for downlink and uplink resource allocation can be modified to include an LE channel indicator field within the DCI format. The CIF would indicate that an allocation or grant is located on a channel in the LE bands, and would consequently indicate the presence of an LE channel indicator field within the DCI format. The LE channel indicator field would then comprise an x-bit field that identifies the exact LE channel (and consequently the component carrier) to which the allocation or grant is associated. The use of an LE channel indicator field to enable cross-carrier-based cell change is shown in FIG. 17.

To allow a WTRU to receive or transmit on a SuppCell, the SuppCell configuration must be sent to the WTRU via RRC messaging. In order to avoid the need to store the RRC information for all potential SuppCells associated with each of the channels in the LE bands as well as the need for updating the information associated with each of these, the eNB may maintain a list of active and dormant cells. Active cells are configured by RRC and correspond to the set of SuppCells that the eNB can cross-carrier schedule at any given time. Dormant cells are known by the WTRU to a minimal extent (e.g. the center frequency for the cell associated to this channel and the bandwidth), but all the corresponding RRC configuration information is not sent to the WTRU. As a result, cell change through the use of cross-carrier scheduling can only be performed between active cells. RRC signaling can be used by the eNB to change the list of active and dormant cells when needed. The list could also be static or semi-static (for example, the active cell information may consist of the frequencies that a base station or operator can support, and may therefore be sent through more static means such as information stored on a USIM).

The use of active and dormant cells also allows for a reduction in the number of measurements that need to be performed by the WTRU. In order to have a minimum amount of channel knowledge to enable scheduling, the eNB may occasionally transmit reference symbols and/or synchronization symbols over the active cell frequencies. The WTRUs may perform measurements of the reference signals and synchronization signals according to the schedule specified by the eNB or based on asynchronous measurement requests commanded by the WTRU. Measurements on dormant cells are not made, and the eNB and WTRU do not transmit any reference or synchronization signals on these cells.

Cell Change through Soft Transition

In any of the cell change mechanisms described herein, the mechanism for cell change in the LE bands may require a soft transition procedure by the MAC layer at the WTRU and eNB. When selecting a new LE channel on which to operate (e.g., due to the detection of a primary user on one of the currently utilized channel), the access to this new channel may not occur immediately. Particularly, the eNB and/or the WTRU may wish to ensure the channel is free by first performing some energy detection for clear channel assessment (CCA) prior to actual transmission. This “Listen-Before-Talk” strategy ensures that the LTE system coexists with other users currently using the LE bands and it also avoids interference from these secondary users during its own channel access.

As a result, a cell change may require a soft transition to be performed by the MAC layer in order to avoid a drop in the available bandwidth during the cell change due to the delay in accessing the channel following the “Listen Before Talk”. In accordance with various embodiments, following a cell change, the MAC layer may maintain a soft transition period wherein transmission is still performed on the source channel/cell until transmission is established on the destination channel/cell. The eNB may stop resource allocation on the source channel/cell at the point it has determined that acceptable transmission has been achieved on the destination channel/cell. In this case, it may be assumed that acceptable transmission is achieved upon the transmission of a transport block and the reception of the corresponding acknowledgement. In other words, the soft transition period may consist of (1) the time period required to gain access to the new channel using CCA plus (2) the time required to successfully transmit a transport block across that channel plus (3) the time required for the WTRU to return an acknowledgement thereof. The second portion of this transition time allows the eNB to adjust the channel estimates and CQI estimates for the new channel while maintaining active transmission bandwidth on the source cell.

An exemplary soft transition procedure in the context of MAC-CE-based cell change is described in more detail below. Similar rules may apply to the other mechanisms for cell change.

### Transition Period for MAC-CE-based Cell Change

In accordance with various embodiments, during the cell change, a single set of HARQ processes is employed for the source and destination cells. As a result, during the soft transition period during which transmission may be occurring simultaneously across both cells, the eNB or WTRU (depending on UL or DL transmission) will select a cell on which a specific process number should be sent. The transmitter will start by selecting a subset of the process number to be transmitted on the new cell (typically, a single process number could be sent on the new cell to enable the transition).

For downlink transmission, since the CIF remains common across the channel switch, the UE will decode PDSCH on both the old and new LE channels initially when a channel switch is first received. Once the process numbers initially transmitted on the new cell are successful, the eNB will move all process numbers to the new cell and the UE will no longer need to decode PDSCH on the old cell. This indicates the end of the transition period for that specific UE.

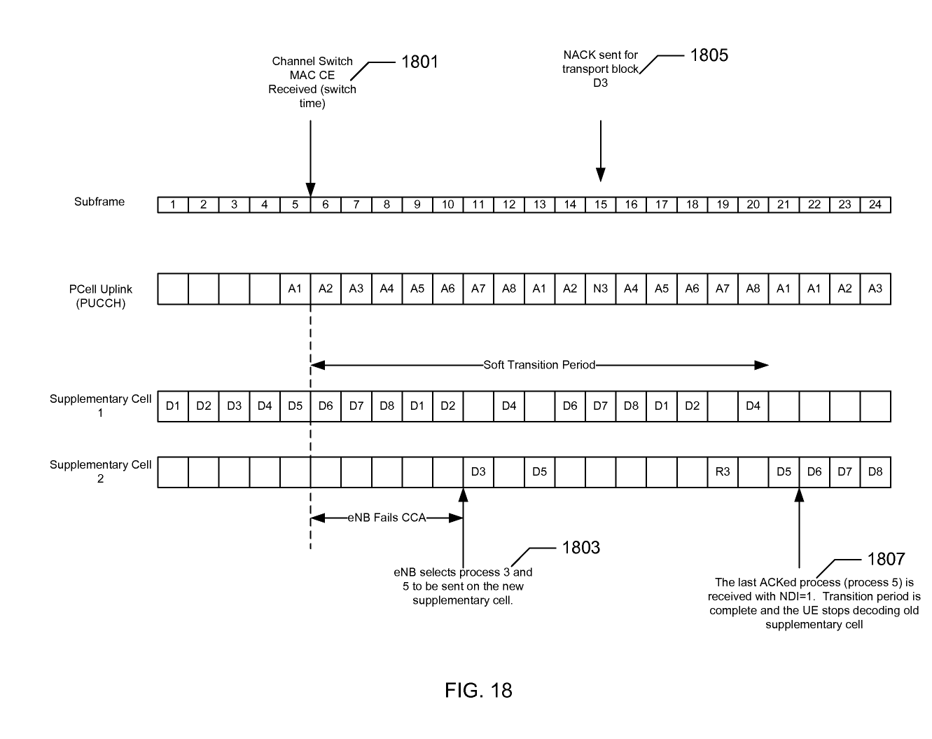

FIG. 18 shows an exemplary timeline of events during the transition period for downlink transmission in terms of pending HARQ transmissions and ACK/NACKs. In FIG. 18, the Channel Switch MAC CE commands a cell change from Supplementary Cell 1 to Supplementary Cell 2 at subframe 6 (see reference number 1801). Starting from this subframe, the eNB attempts CCA until it is able to access the channel at subframe 11. HARQ process 3 and HARQ process 5 are selected to be sent on Supplementary Cell 2 (see reference number 1803), while the other HARQ processes remain on Supplementary Cell 1. Transport block D3 is received incorrectly by the WTRU and a NACK is sent (see 1805), while the WTRU ACKs transport block D5. When a new transport block (indicated by the NDI) with HARQ process number 5 is received by the WTRU (see 1807), this signals the end of the soft transition period and the eNB stops sending data on Supplementary Cell 1. The WTRU, at this time, need only decode PDSCH on Supplementary Cell 2 for the CIF corresponding to this cell.

Although the end of the soft transition period corresponds to the correct transmission and acknowledgement of a single transport block, other criteria are also possible and are within the scope of this disclosure (e.g., correct transmission of x transport blocks).

### Autonomous Spectrum Allocator

Some embodiments of the systems and methods described herein may not rely on a centralized CM entity. In such embodiments, the eNB may make channel allocation decisions based on queries of the TVWS database combined with local sensing/measurement reports. To accomplish this, some embodiments utilize an eNB-operated cell search mechanism. This mechanism aims to minimize the interference caused by the neighboring eNBs and other non-LTE networks through different ways, such as, for example, appropriately selecting the operating carrier; constantly monitoring the channels, and switching to a different operating carrier when it is required; e.g., interference level measured by the eNB is higher than a certain value.

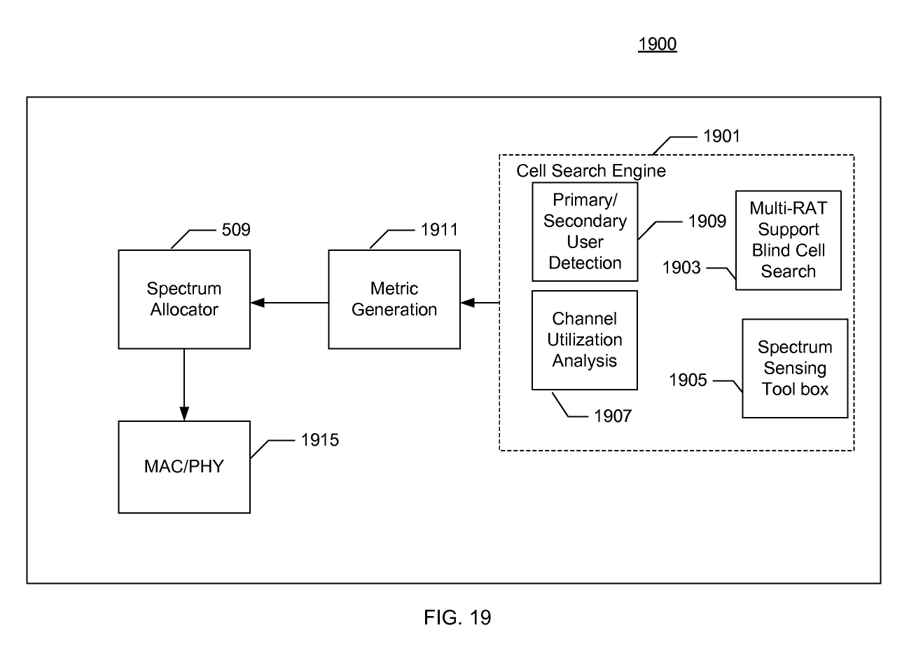

In some embodiments, cell search engine functionality may be included in an eNB. FIG. 19 is a block diagram of relevant components of a cell search enabled eNB 1900 in accordance with one possible embodiment, The cell search engine 1901 may host, for example, the following functions: spectrum sensing (or channel scanning) 1905, e.g., received signal strength indication (RSSI), and channel measurement (e.g., interference measurement); multi-RAT cell search support 1903, which is enabled to detect cells operated with different RATs in parallel or sequentially; primary/secondary user detection (1909); and/or channel utilization analysis 1907.

As shown in FIG. 19, the cell search engine 1901 sends the inputs to the metric generation, which could include the channel utilization analysis and channel measurement results to a Metric Generation block 1911. The Metric Generation block 1911 uses these inputs to generate metrics required by the system and sends them to spectrum allocator 509. The spectrum allocation 509 may use the input from the Metric Generation block 1911 and other factors to determine the operating channel appropriately and configure the MAC and PHY layers 1915 accordingly.

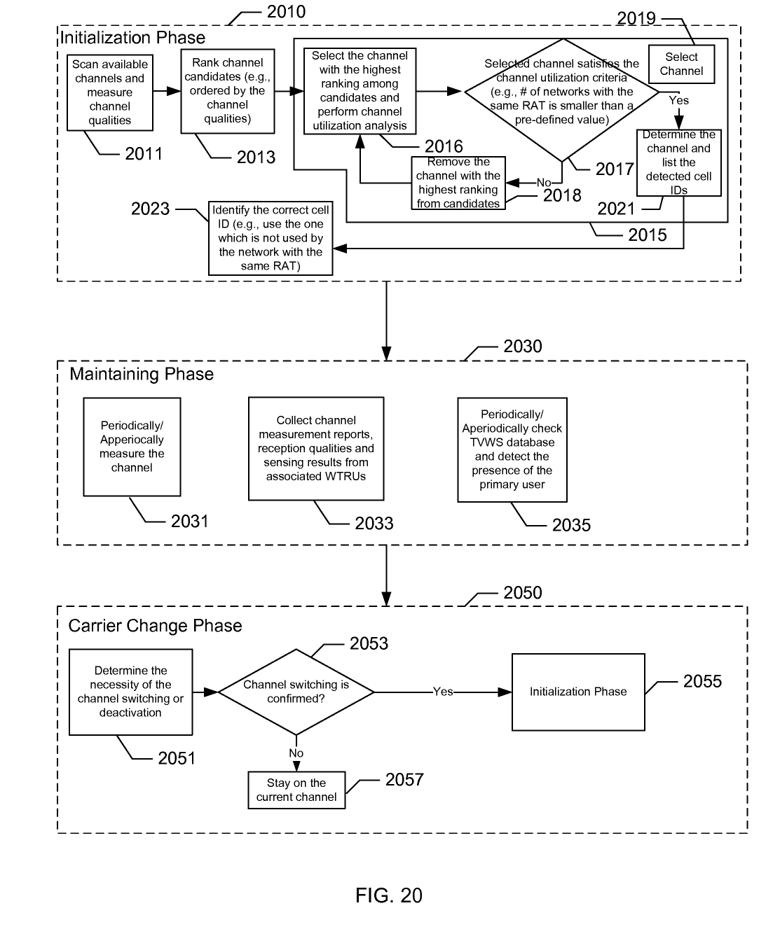

The procedure that eNB performs for cell discovery and monitoring of the surrounding environment may be divided into three phases, which are shown in FIG. 20.

The Initialization Phase 2001 is the phase in which the eNB initially selects the operating carrier or determines the secondary/supplementary carrier. The main tasks of the eNB in this phase are listed below:
1. Scan all channel candidates and measure the channel qualities (i.e., RSSI) (2011)
2. Rank all channel candidates based on the channel quality order (2013), e.g., the channel with lowest RSSI is ranked with No. 1 and so on and so forth;
3. Perform the channel selection procedure (2015: discussed in more detail below);
4. Determine the selected channel and list all cell IDs of the same RAT network on this channel (2021);
5. Use the cell ID that is not used by the same RAT networks on this channel (2023).

Two example embodiments of the channel selection procedure (2015) are described below.

A first channel selection procedure is illustrated in FIG. 20 and may comprise the following steps:
1. Select the channel with the highest ranking and perform channel utilization analysis (2016);
2. Perform channel utilization analysis (2017) to determine if the channel is over-utilized by the network with the same RAT.
3. If so, then the eNB moves to the channel with the 2nd highest ranking (2018) and performs channel utilization analysis on that channel (return to 2016);
4. If, on the other hand, the channel utilization shows the channel is lightly utilized by the network with the same RAT, then the eNB selects this channel (2019).

How the channel utilization is analyzed can be system-defined. As an example, the parameters used for analysis and measurement may include: the number of RATs operated in the channel; the number of networks with the same RAT; and the RSSI from the same RAT networks.

The threshold to determine if the channel is over-utilized or light-utilized by the same RAT networks is system-dependent. It may depend, for example, on the operating technology, performance requirement (e.g., QoS), etc.

A second channel selection procedure may comprise the following steps:
1. Select the channel with the highest ranking and perform interference versus coverage analysis;
2. An example of the interference versus coverage analysis may be determining whether the power used by the eNB to guarantee the desired coverage causes interference above a certain threshold to co-channel sharing eNBs. If so, then the eNB will move to the next ranking channel and perform a similar analysis; if it is not, then the eNB will select this channel and starts to operate on this channel.

To further improve the eNB detection probability and reduce interference from other cells, the location of the synchronization signal of this new carrier may have an offset to the Primary Synchronization Signal (PSS)/Secondary Synchronization Signal (SSS) generated by other networks with the same RAT (e.g., few symbols).

In the Maintaining Phase 2030, the eNB monitor the operating channel conditions and detects the interference appeared in the channel. Example tasks of the eNB in this phase may include:
1. Periodically/a periodically measuring the channel condition (2031), e.g., the measurement of the received interference power at the eNB and analyze the channel usage;
2. Collecting the channel measurement, reception quality reports and sensing results from associated WTRUs, e.g., RSRP, RSRQ and ACK/NACK (2033); and
3. Periodically/a periodically checking the TVWS database and detecting the presence of the primary user (2035).

The channel condition measurement and channel utilization analysis performed by the eNB can be either periodic and/or aperiodic. The events to trigger the eNB to perform measurement and channel utilization analysis may include: the channel measurement from WTRUs is changed more than a pre-defined threshold; and the DL reception quality is changed more than a pre-defined threshold (e.g., the number of NACKs from associated WTRUs in a period of time is larger than a certain value).

The Carrier Change Phase 2050 is the phase in which the eNB switches to the different operating channel or deactivates the secondary/supplementary carrier. Exemplary tasks of the eNB in this phase may include: determining the necessity of the channel switching or deactivation (2051); and, if the channel switching is confirmed (2053), conducting cell search steps (2055), which may be the steps shown in Initialization Phase 2010. If no available channel is found, then this carrier may be deactivated. If, on the other hand, channel switching is not confirmed in 2053, the eNB will simply stay on the current channel (2057).

The criteria used for evaluating whether it is necessary to switch the operating channel or deactivate the carrier is system-dependent. It may depend on one or more of such factors as the operating technology, performance requirement (e.g., QoS), and interference type.

### Embodiments

In one embodiment, a method is implemented in a base station to monitor a spectrum for availability for use, comprising: receiving from a management entity a list of candidate channels within the spectrum; and monitoring at least one of the candidate channels in the list for candidacy for use.

In accordance with this embodiment, the method may further comprise: receiving a set of policies for use of the spectrum.

Any of the preceding embodiments may further comprise receiving coexistence information pertaining to other potential users of the candidate channels within the spectrum.

Any of the preceding embodiments may further comprise wherein at least some of the policies are received from the management entity.

Any of the preceding embodiments may further comprise registering with the management entity.

Any of the preceding embodiments may further comprise selecting one of the candidate channels in the list for use based on the monitoring.

Any of the preceding embodiments may further comprise wherein the candidate channels are ranked.

Any of the preceding embodiments may further comprise wherein the monitoring comprises selecting N of the candidate channels in the list, wherein N is an integer equal to or less than the number of channels in the list.

Any of the preceding embodiments may further comprise wherein the N channels are selected based on the coexistence information and the policies.

Any of the preceding embodiments may further comprise wherein the coexistence information comprises at least a channel type, wherein channel types include: (1) sub-licensed channels comprising channels that are dedicated for use by the base station; (2) primary user assigned channels comprising channels that are licensed to a primary user that is not the base station but that may be used by users other than the primary user when such use will not interfere with the primary user's use of the channel; and (3) available channels comprising channels that are available for use by the base station and unlicensed users and that are not primary user assigned channels.

Any of the preceding embodiments may further comprise wherein the N channels are ranked.

Any of the preceding embodiments may further comprise wherein the ranking of the N channels comprises prioritizing sub-licensed channels above available channels, and prioritizing available channels above primary user assigned channels.

Any of the preceding embodiments may further comprise wherein the ranking of the N channels is at least partially a function of allowed transmit power with regard to a cell size of the base station.

Any of the preceding embodiments may further comprise wherein the monitoring comprises monitoring at least the channels of the N channels that are not of the sublicensed channel type.

Any of the preceding embodiments may further comprise transmitting to the management entity the identities of the N channels.

Any of the preceding embodiments may further comprise transmitting to the management entity the identities of the channels being monitored by the base station.

Any of the preceding embodiments may further comprise transmitting to wireless transmit/receive units (WTRUs) in communication with the base station a message to configure said WTRUs to monitor at least one of the candidate channels.

Any of the preceding embodiments may further comprise wherein the ranking is base at least partially on the monitoring.

Any of the preceding embodiments may further comprise wherein the monitoring comprises feature detection.

Any of the preceding embodiments may further comprise wherein the feature detection includes determination of the wireless communication protocol of users of the candidate channels.

Any of the preceding embodiments may further comprise wherein the ranking is at least partially a function of the feature detection.

Any of the preceding embodiments may further comprise responsive to detection of a particular usage of a channel by at least one other user, commencing a candidate channel monitoring re-election procedure.

Any of the preceding embodiments may further comprise wherein the candidate channel monitoring re-election procedure comprises transmitting a message to the management entity for an updated channel list.

Any of the preceding embodiments may further comprise wherein the candidate channel monitoring re-election procedure comprises removing the channel on which the particular usage was detected from the N channels and replacing it with a different channel in the updated channel list.

Any of the preceding embodiments may further comprise receiving from the management entity a notice of a status change of a candidate; and responsive to the notice of status change, commencing a candidate channel monitoring re-election procedure.

Any of the preceding embodiments may further comprise wherein the coexistence information comprises at least a channel type, wherein channel types include: (1) sub-licensed channels comprising channels that are dedicated for use by the base station; (2) primary user assigned channels comprising channels that are licensed to a primary user that is not the base station but that may be used by users other than the primary user when such use will not interfere with the primary user's use of the channel; and (3) available channels comprising channels that are available for use by the base station and unlicensed users and that are not primary user assigned channels and wherein the candidate channel monitoring re-election procedure comprises: responsive to the status change comprising one of the N channels becoming a sub-licensed channel type by another user, removing that one of the N channels from the list of N channels and replacing it with a different channel.

Any of the preceding embodiments may further comprise wherein the coexistence information comprises at least a channel type, wherein channel types include: (1) sub-licensed channels comprising channels that are dedicated for use by the base station; (2) primary user assigned channels comprising channels that are licensed to a primary user that is not the base station but that may be used by users other than the primary user when such use will not interfere with the primary user's use of the channel; and (3) available channels comprising channels that are available for use by the base station and unlicensed users and that are not primary user assigned channels and wherein the candidate channel monitoring re-election procedure comprises: responsive to the status change comprising one of the N channels becoming a primary user channel type, reconfiguring the base station to monitor said one of the N channels to for primary user usage.

Any of the preceding embodiments may further comprise wherein the candidate channel monitoring re-election procedure comprises, responsive to the status change comprising one of the N channels being used by a secondary user, removing that one of the N channels from the list of N channels and replacing it with a different channel.

Any of the preceding embodiments may further comprise wherein the candidate channel monitoring re-election procedure comprises, responsive to the status change comprising a channel within the spectrum becoming available for use, removing one of the channels from the list of N channels and replacing it with the channel that became available.

Any of the preceding embodiments may further comprise periodically transmitting a message to the management entity requesting an updated candidate channel list; and commencing a candidate channel monitoring re-election procedure responsive to changes in the updated candidate channel list as compared to the candidate channel list previously received from the management entity.

Any of the preceding embodiments may further comprise wherein the policy is regulated by a base station policy engine.

Any of the preceding embodiments may further comprise wherein the base station policy engine combines an operator policy and a local policy to generate a constraint for the base station.

Any of the preceding embodiments may further comprise wherein the monitoring comprises: interacting with the management entity; selecting, by the base station, one or more candidate channels; configuring, by the base station, a cognitive sensing capable wireless transmit/receive unit (WTRU) to start inter-frequency measurement.

Any of the preceding embodiments may further comprise receiving, from the base station, a detection event from the WTRU.

Any of the preceding embodiments may further comprise wherein the detection event indicates a usage of the channel by a secondary user.

Any of the preceding embodiments may further comprise wherein the detection event indications a usage of the channel by a primary user.

Any of the preceding embodiments may further comprise wherein the detection event is received via RRC signaling.

Any of the preceding embodiments may comprise receiving from the coexistence manager updated information when a triggering event is satisfied.

Any of the preceding embodiments may further comprise wherein the triggering event is a neighbor base station allocating a channel.

Any of the preceding embodiments may further comprise wherein the triggering event is a channel usage that exceeds a threshold.

Any of the preceding embodiments may further comprise wherein the triggering event is a change in channel type of a channel in the channel list.

Any of the preceding embodiments may further comprise wherein the triggering event is the addition of a potential candidate channel to the channel list.

Any of the preceding embodiments may further comprise wherein the spectrum is a Licensed Exempt spectrum.

In another embodiment or in connection with any of the preceding described embodiments, a system for allocating wireless communication channels within a spectrum may comprise: a coexistence manager adapted to transmit a list of candidate channels within the spectrum; a wireless transmit/receive unit (WTRU); a base station in communication with the coexistence manager and the wireless transmit/receive unit, the base station configured to: receive from a management entity a list of candidate channels within the spectrum; and monitor at least one of the candidate channels in the list for candidacy for use by the base station.

Any of the preceding embodiments may further comprise wherein the base station comprises: a policy engine configured to store policies relating to channel allocation within the spectrum; a spectrum allocator configured to receive the policies from the policy engine, to receive the list of candidate channels from the coexistence management entity and to configure monitoring of at least a subset of the channels in the candidate channel list; and a RRM management and control entity configured to manage communications between the base station and the coexistence management entity.

Any of the preceding embodiments may further comprise wherein the spectrum allocator is configured to provide LE usage information to the coexistence manager.

Any of the preceding embodiments may further comprise a sensing processor adapted to monitor the at least one candidate channel.

Any of the preceding embodiments may further comprise wherein the spectrum allocator is further configured to send a first sensing configuration message to the sensing processor for configuring the sensing processor to monitor the at least one candidate channel.

Any of the preceding embodiments may further comprise wherein the RRM management and control entity is configured to send a configuration request message to the coexistence management entity, to receive from the coexistence management entity a configuration response message including the list of candidate channels, and to send the list of candidate channels to the spectrum allocator.

Any of the preceding embodiments may further comprise wherein the configuration response message further includes policy information relating to channel allocation within the spectrum and wherein the RRM management and control entity is further configured to send the policy information to the policy engine.

Any of the preceding embodiments may further comprise wherein the spectrum allocator is further configured to send a second sensing configuration message for configuring the WTRU to monitor the at least one candidate channel to the to the RRM management and control entity and the RRM management and control entity is further configured to send an RRC measurement reconfiguration message to the WTRU including information for configuring the WTRU to monitor the at least one candidate channel.

In another embodiment or in connection with any of the preceding described embodiments, a method for allocating use by the base station of channels within a Licensed Exempt spectrum may comprise: receiving from a coexistence management entity a list of candidate channels within the spectrum; monitoring at least one of the candidate channels in the list for candidacy for use; using at least one of the candidate channels for communications with a wireless transmit/receive unit (WTRU); detecting when a change in the status of the at least one channel has occurred; responsive to detection of a change in status of the at least one channel, determining whether the at least one channel is still available for use by the base station; and if it is determined that the at least one channel is not available for use by the base station, switching to a different channel.

Any of the preceding embodiments may further comprise, if the status change comprises use of the at least one channel by a primary user, evacuating the channel.

Any of the preceding embodiments may further comprise, if the status change comprises the at least one channel being assigned to a primary user, reconfiguring the monitoring of the at least one channel to include primary user monitoring.

Any of the preceding embodiments may further comprise, if the status change comprises the at least one channel being used by a primary user, evacuating the channel.

Any of the preceding embodiments may further comprise, if the status change comprises use of the at least one channel by a secondary user other than the base station that exceeds a threshold, evacuating the channel.

Any of the preceding embodiments may further comprise receiving notification from the management entity of a change in status of the at least one channel being used for communications and reconfiguring the monitoring of the at least one channel in response to the status change.

In another embodiment or in connection with any of the preceding described embodiments, a method for switching communications between a base station and at least one wireless transmit/receive unit (WTRU) from a first channel in a Licensed Exempt spectrum to a second channel may comprise: receiving at the base station a channel switch request that identifies the second channel to which communications is to be switched; creating at the base station a MAC PDU containing a Channel Switch MAC CE, the Channel Switch MAC CE including information contained in the channel switch request; transmitting the MAC PDU from the base station to the at least one WTRU; receiving the MAC PDU at the at least one WTRU; transmitting from the base station to the at least one WTRU a RRC Connection Reconfiguration message; and reconfiguring the communication between the base station and the at least one WTRU using RRC messaging.

Any of the preceding embodiments may further comprise wherein the channel switch request is received in a RRC layer of the base station.

Any of the preceding embodiments may further comprise, responsive to receiving the channel switch request message, the base station disabling RRM-related processing and forwarding the channel switch request message to a MAC layer, wherein the MAC layer creates the MAC PDU.

Any of the preceding embodiments may further comprise wherein the MAC layer sends a channel switch time indication message to the RRC layer disclosing a frame at which the channel switch is to occur.

Any of the preceding embodiments may further comprise wherein, the at least one WTRU maintains HARQ buffers and context information after receiving the MAC PDU.

Any of the preceding embodiments may further comprise wherein the MAC CE comprises at least one of: a Carrier Indicator Field (CIF) identifying a carrier that will undergo the channel switch; a Target Channel Number identifying the second channel; a Max Power filed specifying the maximum power at which the at least one WTRU can transmit on the second channel; a Frame and/or Subframe Number containing a SFN at which the channel switch is to occur; a New Cell ID indicating a physical Cell ID of the second channel.

In another embodiment or in connection with any of the preceding described embodiments, a method for switching communications between a base station and at least one wireless transmit/receive unit (WTRU) from a first channel in a Licensed Exempt spectrum to a second channel may comprise: receiving at the base station a channel switch request that identifies the second channel to which communications is to be switched; an RRC layer of the base station triggering a turn on of the second channel, creating an RRC portion of a channel switch message, and sending information to a MAC layer of the base station related to the second channel; the MAC layer determining a time at which the channel switch will occur and creating a MAC portion of the channel switch message an indication of the time at which the channel switch will occur; allocating the channel switch to a set of resource blocks, and mapping an associated channel switch DCI format to a PDCCH and PDSCH and transmitted the DCI to the at least one WTRU; a MAC layer of the WTRU reading the MAC section of the channel switch message and beginning using the designated parameters as of the channel switch time; and a RRC layer of the WTRU reading the MAC section of the channel switch message and reconfiguring measurements to be performed on the second channel in accordance therewith.

In another embodiment or in connection with any of the preceding described embodiments, a method for spectrum allocation may comprise: assigning, by a spectrum allocator in a base station node, a first frequency of operation of a node in a wireless communication network within a licensed exempt band; and responsive to a triggering event, reassigning, by the spectrum allocator, the node to a second frequency of operation within the licensed exempt band.

Any of the preceding embodiments may further comprise wherein the assignment of the first frequency of operation is based on a report from a cognitive sensing capable WTRU.

Any of the preceding embodiments may further comprise wherein prior to reassigning the node to the second frequency of operation, the first frequency of operation is monitored.

Any of the preceding embodiments may further comprise wherein the licensed exempt band is TV whitespace (TVWS).

Any of the preceding embodiments may further comprise wherein the triggering event is a change in the availability of the first frequency of operation.

Any of the preceding embodiments may further comprise wherein the triggering event is a change in the quality of the first frequency of operation.

Any of the preceding embodiments may further comprise wherein the reassignment to the second frequency of operation is a seamless channel change.

Any of the preceding embodiments may further comprise wherein the seamless channel changes uses a MAC control element.

In other embodiments, an apparatus may be configured to perform any of the previously mentioned methods.

In other embodiments, a tangible computer readable storage medium may have stored therein a data structure loadable into a memory of a computing device and usable by an entity for performing any of the previously mentioned methods.

### CONCLUSION

The following United States (US) patent application (Pat. App.) is incorporated herein by reference in its entirety: U.S. patent application Ser. No. 13/271,806 filed 12 Oct. 2011. The following U.S. Provisional patent application (Prov. Pat. App.) is incorporated herein by reference in its entirety: U.S. Prov. Pat. App. Ser. No. 61/560,571 filed 16 Nov. 2011.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer readable medium for execution by a computer or processor. Examples of non-transitory computer-readable storage media include, but are not limited to, a read only memory (ROM), random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Moreover, in the embodiments described above, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits.

The data bits may also be maintained on a computer readable medium including magnetic disks, optical disks, and any other volatile (e.g., Random Access Memory (“RAM”)) or non-volatile (“e.g., Read-Only Memory (“ROM”)) mass storage system readable by the CPU. The computer readable medium may include cooperating or interconnected computer readable medium, which exist exclusively on the processing system or are distributed among multiple interconnected processing systems that may be local or remote to the processing system. It is understood that the exemplary embodiments are not limited to the above-mentioned memories and that other platforms and memories may support the described methods.

No element, act, or instruction used in the description of the present application should be construed as critical or essential unless explicitly described as such. Also, as used herein, the article “a” is intended to include one or more items. Where only one item is intended, the term “one” or similar language is used. Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Further, as used herein, the term “set” is intended to include any number of items, including zero. Further, as used herein, the term “number” is intended to include any number, including zero.

Moreover, the claims should not be read as limited to the described order or elements unless stated to that effect. In addition, use of the term “means” in any claim is intended to invoke 35 U.S.C. §112, ¶ 6, and any claim without the word “means” is not so intended.

Although the systems and methods herein have been described in terms of a UWB multi-band communication system, it is contemplated that it may be implemented in software on microprocessors/general purpose computers (not shown). In certain embodiments, one or more of the functions of the various components may be implemented in software that controls a general-purpose computer.

1. A method implemented in a base station to monitor a spectrum for availability for use, comprising:
receiving from a management entity a list of candidate channels within the spectrum; and
monitoring at least one of the candidate channels in the list for candidacy for use.

2. The method of claim 1 wherein the receiving the list of candidate channels further comprises receiving coexistence information pertaining to other potential users of the candidate channels within the spectrum.

3. The method of claim 1 further comprising:
selecting at least one of the candidate channels in the list for use based on the monitoring.

4. The method of claim 3 wherein the monitoring comprises:
selecting N of the candidate channels, wherein N is an integer equal to or less than the number of candidate channels.

5. The method of claim 1 further comprising transmitting to the management entity the identities of the channels being monitored by the base station.

6. The method of claim 1 further comprising:
transmitting to wireless transmit/receive units (WTRUs) in communication with the base station a message to configure said WTRUs to monitor at least one of the N candidate channels.

7. The method of claim 1 further comprising:
responsive to detection of a particular usage of a channel by at least one other user, commencing a candidate channel monitoring re-election procedure.

8. The method of claim 3 further comprising:
responsive to detection of a particular usage of a channel by at least one other user, commencing a candidate channel monitoring re-election procedure.

9. The method of claim 8 wherein the candidate channel monitoring re-election procedure comprises transmitting a message to the management entity requesting an updated candidate channel list.

10. The method of claim 9 wherein the candidate channel monitoring re-election procedure comprises removing from the N channels the channel on which the particular usage was detected and replacing it with a different channel from the updated channel list.

11. The method of claim 1 further comprising:
receiving from the management entity a notice of a status change of a candidate channel; and
responsive to the notice of status change, commencing a candidate channel monitoring re-election procedure.

12. The method of claim 3 further comprising:
receiving from the management entity a notice of a status change of a candidate channel; and
responsive to the notice of status change, commencing a candidate channel monitoring re-election procedure.

13. The method of claim 1 wherein the monitoring comprises:
interacting with the management entity;
selecting, by the base station, one or more candidate channels; and
configuring, by the base station, a cognitive sensing capable wireless transmit/receive unit (WTRU) to start inter-frequency measurement.

14. The method of claim 13 wherein the configuring of the cognitive sensing capable WTRU by the base station is performed via RRC signaling.

15. The method of claim 13 further comprising:
receiving, from the base station, a detection event from the WTRU.

16. The method of claim 15 wherein the detection event indicates a usage of the channel by a secondary user.

17. The method of claim 15 wherein the detection event indications a usage of the channel by a primary user.

18. The method of claim 15 wherein the detection event is received via RRC signaling.

19. The method of claim 1 comprising:
receiving from the coexistence manager updated information when a triggering event is satisfied.

20. The method of claim 19 wherein the triggering event is another base station allocating a channel.

21. The method of claim 19 wherein the triggering event is channel usage that exceeds a threshold.

22. The method of claim 19, wherein the triggering event is a change in channel type of a channel in the channel list.

23. The method of claim 19 wherein the triggering event is the addition of a candidate channel to the channel list.

24. A method implemented in a base station for allocating use by the base station of channels within a Licensed Exempt spectrum, the method comprising:
receiving from a coexistence management entity a list of candidate channels within the spectrum;
monitoring at least one of the candidate channels in the list for candidacy for use;
using at least one of the candidate channels for communications with a wireless transmit/receive unit (WTRU);
detecting when a change in the status of the at least one channel has occurred;
responsive to detection of a change in status of the at least one channel, determining whether the at least one channel is still available for use by the base station; and
if it is determined that the at least one channel is not available for use by the base station, switching to a different channel.

25. The method of claim 24 further comprising:
if the status change comprises use of the at least one channel by a primary user, evacuating the channel.

26. The method of claim 24 further comprising:
if the status change comprises the at least one channel being assigned to a primary user, reconfiguring the monitoring of the at least one channel to include primary user monitoring.

27. The method of claim 26 further comprising:
if the status change comprises use of the at least one channel by a secondary user other than the base station that exceeds a threshold, evacuating the channel.

28. A method for switching communications between a base station and at least one wireless transmit/receive unit (WTRU) from a first channel in a Licensed Exempt spectrum to a second channel, the method comprising:
receiving at the base station a channel switch request that identifies the second channel to which communications is to be switched;
creating at the base station a MAC PDU containing a Channel Switch MAC CE, the Channel Switch MAC CE including information contained in the channel switch request;
transmitting the MAC PDU from the base station to the at least one WTRU;
receiving the MAC PDU at the at least one WTRU;
transmitting from the base station to the at least one WTRU a RRC Connection Reconfiguration message; and
reconfiguring the communication between the base station and the at least one WTRU using RRC messaging.

29. The method of claim 28 wherein the MAC CE comprises at least one of:
a Carrier Indicator Field (CIF) identifying a carrier that will undergo the channel switch;
a Target Channel Number identifying the second channel;
a Max Power filed specifying the maximum power at which the at least one WTRU can transmit on the second channel;
a Frame and/or Subframe Number containing a SFN at which the channel switch is to occur; and
a New Cell ID indicating a physical Cell ID of the second channel.

30. A method for switching communications between a base station and at least one wireless transmit/receive unit (WTRU) from a first channel in a Licensed Exempt spectrum to a second channel, the method comprising:
receiving at the base station a channel switch request that identifies the second channel to which communications is to be switched;
an RRC layer of the base station triggering a turn on of the second channel, creating an RRC portion of a channel switch message, and sending information to a MAC layer of the base station related to the second channel;
the MAC layer determining a time at which the channel switch will occur and creating a MAC portion of the channel switch message containing an indication of the time at which the channel switch will occur;
allocating the channel switch to a set of resource blocks, and mapping an associated channel switch DCI format to a PDCCH and PDSCH and transmitted the DCI to the at least one WTRU;
a MAC layer of the WTRU reading the MAC section of the channel switch message and beginning using the designated parameters as of the channel switch time; and
a RRC layer of the WTRU reading the MAC section of the channel switch message and reconfiguring measurements to be performed on the second channel in accordance therewith.
